(19) United States
(12) Patent Application Publication
(10) Pub. No.: US 2025/0350962 A1
(43) Pub. Date: Nov. 13, 2025

(54) APPARATUS AND METHOD FOR COMMUNICATING AI/ML INFORMATION

(71) Applicant: Lenovo (Singapore) Pte Ltd, Singapore (SG)

(72) Inventors: Tapisha Soni, Munich (DE); Vahid Pourahmadi, Munich (DE); Joachim Löhr, Wiesbaden (DE)

(73) Assignee: Lenovo (Singapore) Pte Ltd, Singapore (SG)

(21) Appl. No.: 18/659,654

(22) Filed: May 9, 2024

(51) Int. Cl. H04W 24/02; H04L 5/00; H04W 8/22

(52) U.S. Cl. CPC H04W 24/02; H04L 5/0053; H04W 8/22

(57) ABSTRACT

Various aspects of the present disclosure relate to an apparatus and method for communicating artificial intelligence (AI)/machine learning (ML) information. A request message for information associated with AI can be received from a network entity. A response message including applicability-related information associated with at least one AI functionality supported by a UE can be transmitted to the network entity based at least in part on the received request message.

### CROSS-REFERENCE TO RELATED APPLICATIONS

This application is related to an application entitled, “APPARATUS AND METHOD FOR SIGNALING AI/ML FUNCTIONALITY,” Lenovo docket number SMM920240065-US-NP, filed on even date herewith, commonly assigned to the assignee of the present application, and which is hereby incorporated by reference.

### TECHNICAL FIELD

The present disclosure relates to wireless communications, and more specifically to an apparatus and method for communicating artificial intelligence (AI)/machine learning (ML) information.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources, such as time resources (e.g., symbols, slots, subframes, frames, or the like) and/or frequency resources (e.g., subcarriers, carriers, or the like), of the wireless communication system. Additionally, the wireless communications system may support wireless communications across various radio access technologies including third-generation (3G) radio access technology, fourth-generation (4G) radio access technology, fifth-generation (5G) radio access technology, among other suitable radio access technologies beyond 5G (e.g., sixth-generation (6G)).

### SUMMARY

Some implementations of the method and apparatuses described herein can provide for communicating AI/ML information. A request message for information associated with AI can be received from a network entity. A response message including applicability-related information associated with at least one AI functionality supported by a UE can be transmitted to the network entity based at least in part on the received request message.

### BRIEF DESCRIPTION OF THE DRAWINGS

In order to describe the manner in which advantages and features of the disclosure can be obtained, a description of the disclosure is rendered by reference to specific embodiments thereof which are illustrated in the appended drawings. These drawings depict only example embodiments of the disclosure and are not therefore to be considered to be limiting of its scope. The drawings may have been simplified for clarity and are not necessarily drawn to scale.

FIG. 1 illustrates an example of a wireless communications system in accordance with aspects of the present disclosure.

FIG. 2 is an example illustration of AI/ML framework in accordance with aspects of the present disclosure.

FIG. 3 is an example illustration of a first one-sided model case in accordance with aspects of the present disclosure.

FIG. 4 is an example illustration of a second one-sided model case in accordance with aspects of the present disclosure.

FIG. 5 is an example illustration of a UE capability framework signal flow diagram for AI/ML functionality in accordance with aspects of the present disclosure.

FIG. 6 is an example illustration of a signal flow diagram for an AI/ML applicability request/response in accordance with aspects of the present disclosure.

FIG. 7 is an example illustration of a signal flow diagram for an AI/ML applicability request/response in accordance with aspects of the present disclosure.

FIG. 8 is an example illustration of signal flow diagram for AI/ML functionality status reporting in accordance with aspects of the present disclosure.

FIG. 9 is an example illustration of signal flow diagram for AI/ML functionality status reporting in accordance with aspects of the present disclosure.

FIG. 10 is an example illustration of a signal flow diagram for AI/ML applicability reporting in accordance with aspects of the present disclosure.

FIG. 11 is an example illustration of a signal flow diagram for request/response of additional conditions for a network (NW)-sided AI/ML model in accordance with aspects of the present disclosure.

FIG. 12 is an example illustration of a signal flow diagram for reporting of applicability and additional conditions for a two-sided AI/ML model in accordance with aspects of the present disclosure.

FIG. 13 is an example illustration of a signal flow diagram for reporting of applicability and additional conditions for a two-sided AI/ML model in accordance with aspects of the present disclosure.

FIG. 14 illustrates an example of a UE in accordance with aspects of the present disclosure.

FIG. 15 illustrates an example of a processor in accordance with aspects of the present disclosure.

FIG. 16 illustrates an example of a network equipment (NE) in accordance with aspects of the present disclosure.

FIG. 17 illustrates a flowchart of a method in accordance with aspects of the present disclosure.

FIG. 18 illustrates a flowchart of a method in accordance with aspects of the present disclosure.

### DETAILED DESCRIPTION

One or multiple AI/ML models may be configured (e.g., trained, deployed, tailored, implemented, executed, programed, etc.) for a given application (i.e., use case). For example, these AI/ML models may be configured for and applicable to specific events, conditions, scenarios, configurations, locations, and deployments, among other factors. After configuring (e.g., training) the AI/ML models, there can be multiple AI/ML models deployed at a first node (also referred to as Node A-side), such as a UE, as well as at one or more second nodes (also referred to as Node Bs), such as base stations. Additionally, after configuring (e.g., training) the AI/ML models, there can be multiple AI/ML models deployed at the one or more second nodes (e.g., at Node B-side), where each second node may be associated with a different first node (e.g., different Node As).

Given multiple AI/ML models for a single functionality, which may be scenario-specific, cell-specific, a configuration-specific, condition specific, etc., it may be desirable to have a mechanism for one or more nodes (e.g. a Node A and/or a Node B) to select an appropriate AI/ML model during an inference phase. In some cases, it can be assumed (e.g., inferred, estimated) that the network, such as a Node B/base station, has a certain level of control to ensure efficient management (e.g., selecting, activating, deactivating, switching) of AI/ML models/functionality for one-sided AI/ML models (e.g., a Node A-side). A suitable AI/ML model may be selected for a current Node A and/or Node B state, which may be defined by one or more conditions/additional conditions associated with the Node A and/or Node B. In some cases, it may be challenging to coordinate between the Node A and the Node B to ensure that a suitable AI/ML model for a corresponding AI/ML functionality and configuration can be selected, while maintaining performance. Various aspects of the present disclosure address this challenge.

For example, different signaling procedures can address the challenge. The signaling procedures can provide support for the exchange of information among different involved nodes (e.g., UE and gNB) to allow an appropriate AI/ML model selection for AI/ML functionality. Followed by a response from a UE, a gNB can configure the UE for the supported and applicable configuration of AI/ML functionality. A node, e.g. UE, transmits its applicability of AI/ML functionality/model that it reported as its capability (UE capability framework) to a second node, e.g., gNB, and different configurations supported for the functionality. Additionally, information about additional conditions of the AI/ML model is exchanged. This enables a node (e.g., UE) to report information of applicable functionality that supports the other node (e.g. gNB) to directly configure the UE for a desired configuration, if available. These signaling mechanisms are presented for UE-sided AI/ML models, NW-sided AI/ML models, and two-sided UE AI/ML models.

In some aspects, in the functionality-based life cycle management (LCM) procedure, one potential method can be that the first node (e.g., UE) may somehow only report to the second node (e.g., gNB) about the AI/ML models/functionalities in general. However, the second node may not be aware of the availability of the potential AI/ML models applicable for the current scenario or configuration of the second node. In this case, the second node (gNB) may configure the first node for the AI/ML functionality without knowing if there exists an applicable model for the functionality meaning functionality is applicable for the second node. The first node may autonomously select an AI/ML model for the functionality or fall back to legacy operation without coordinating with the second node about the status of the AI/ML model/functionality. Alternatively, the second node may not be informed about the functionality supported by the first node, and the AI/ML functionality LCM is completely controlled by the first node. This leaves no room for the network to manage or assist the first node in the AI/ML LCM procedure. At least some embodiments can address this issue.

Aspects of the present disclosure are described in the context of a wireless communications system.

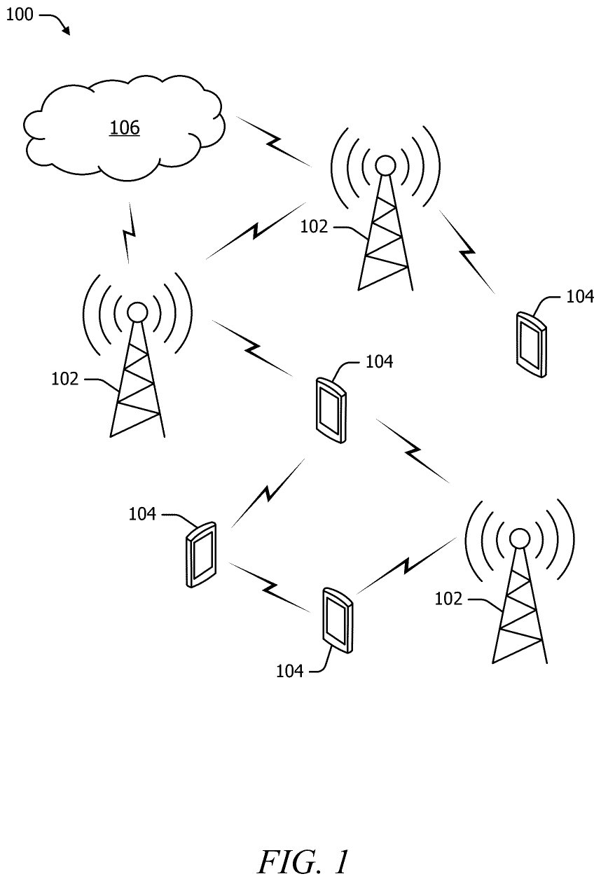

FIG. 1 illustrates an example of a wireless communications system 100 in accordance with aspects of the present disclosure. The wireless communications system 100 may include one or more NE 102, one or more UE 104, and a network 106. The wireless communications system 100 may support various radio access technologies. In some implementations, the wireless communications system 100 may be a fourth-generation (4G) network, such as a long-term evolution (LTE) network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be one of, or a combination of, a 4G network, a 5G network, a Third Generation Partnership Project (3GPP)-based network, one or more of a future generation network (6G, etc.), and/or one or more of any other suitable radio access technology, wireless access technology, and/or wired access technology, including Institute of Electrical and Electronics Engineers (IEEE) 802.11 (Wi-Fi), IEEE 802.16 (WiMAX), IEEE 802.20, a Wireless Local Area Networks (WLAN), a satellite communications network, high-altitude platform network, the Internet, and/or other communications networks. The wireless communications system 100 may support radio access technologies beyond 5G, for example, 6G. Additionally, the wireless communications system 100 may support various multiple access technologies, such as time division multiple access (TDMA), frequency division multiple access (FDMA), code division multiple access (CDMA), Orthogonal Frequency Division Multiple Access (OFDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), an access point, a transmission-reception point (TRP), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NEs 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the network 106, or with another NE 102, or both. For example, an NE 102 may interface with another NE 102 or the network 106 through one or more backhaul links (e.g., S1, N2, N2, or network interface). In some implementations, the NE 102 may communicate with each other directly. In some other implementations, the NE 102 may communicate with each other or indirectly (e.g., via the network 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or TRPs.

The network 106 may support user authentication, access authorization, tracking, connectivity, and other access, routing, or mobility functions. The network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the network 106.

The network 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the network 106 via an NE 102. The network 106 may route traffic (e.g., control information, data, and the like) between the UE 104 and the application server using the established session (e.g., the established PDU session). The PDU session may be an example of a logical connection between the UE 104 and the network 106 (e.g., one or more network functions of the network 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data, etc.). For example, communications traffic can include user data, control information, and other communications traffic. The control information can be used for establishing and controlling communications that transmit and receive the user data, such as in packets, in physical shared channels, in data regions of subframes, and in other communications.

In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

A list of at least some abbreviations above and at least some other abbreviations relevant to at least some embodiments of the present disclosure is provided at the end of this detailed description for ease of reference.

Embodiments can provide an apparatus and method for communicating AI/ML information. At least some embodiments can provide for signaling for one-sided AI/ML framework.

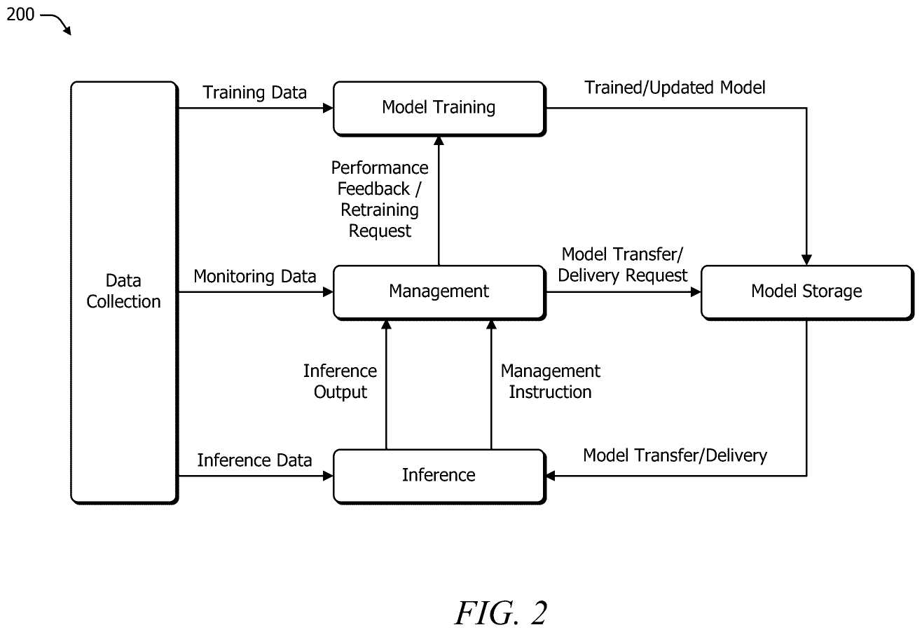

FIG. 2 is an example illustration of AI/ML framework 200 in accordance with aspects of the present disclosure. The AI/ML framework can include Data Collection, Model Training, Management, Inference, and Model Storage. Data Collection is a function that provides input data to the Model Training, Management, and Inference functions. Training Data is data needed as input for the AI/ML Model Training function. Monitoring Data is data needed as input for the Management of AI/ML models or AI/ML functionalities. Inference Data is data needed as input for the AI/ML Inference function.

Model Training is a function that performs AI/ML model training, validation, and testing which may generate model performance metrics that can be used as part of the model testing procedure. The Model Training function is also responsible for data preparation (e.g., data pre-processing and cleaning, formatting, and transformation) based on Training Data delivered by a Data Collection function if required. Management is a function that oversees the operation (e.g., selection/(de)activation/switching/fallback) and monitoring (e.g., performance) of AI/ML models or AI/ML functionalities. This function is also responsible for making decisions to ensure the proper inference operation based on data received from the Data Collection function and the Inference function. Management Instruction is the information needed as input to manage the Inference function. Concerning information may include selection/(de)activation/switching of AI/ML models or AI/ML-based functionalities, fallback to non-AI/ML operation (i.e., not relying on inference process), etc. Model transfer/delivery request is used to request model(s) to the Model Storage function. Performance feedback/retraining request is the information needed as input for the Model Training function, e.g., for model (re)training or updating purposes. Inference is a function that provides outputs from the process of applying AI/ML models or AI/ML functionalities, using the data that is provided by the Data Collection function (i.e., Inference Data) as input. For example, inference can be the process of using a trained AI model to make new predictions on new data. The Inference function is also responsible for data preparation (e.g., data pre-processing and cleaning, formatting, and transformation) based on Inference Data delivered by a Data Collection function, if required. Inference Output is data used by the Management function to monitor the performance of AI/ML models or AI/ML functionalities. Model Storage is a function responsible for storing trained/updated models that can be used to perform the Inference function.

LCM of AI/ML model/functionality is studied in a 3GPP Release 18 AI/ML for air interface study item. Two flavors of AI/ML LCM are considered: Model-ID-based LCM and functionality-based LCM.

In functionality-based LCM, the network indicates activation/deactivation/fallback/switching of AI/ML functionality via 3GPP signalling (e.g., RRC, MAC-CE, DCI). Models may not be identified at the Network, and UE may perform model-level LCM. Whether and how much awareness/interaction the network should have about model-level LCM may require further study. For functionality identification, there may be either one or more than one functionality defined within an AI/ML-enabled feature, where the AI/ML-enabled feature can refer to a feature where AI/ML may be used. A UE may have one AI/ML model for the functionality, or UE may have multiple AI/ML models for the functionality.

For AI/ML functionality identification and functionality-based LCM of UE-side models and/or UE-part of two-sided models, functionality refers to an AI/ML-enabled Feature/feature group (FG) enabled by configuration(s), where configuration(s) is/are supported based on conditions indicated by UE capability. Correspondingly, functionality-based LCM operates based on at least one configuration of AI/ML-enabled Feature/FG or specific configurations of an AI/ML-enabled Feature/FG.

After functionality identification, mechanisms for UE can be used to report updates on applicable functionality(es) among functionality(es), where the applicable functionalities may be a subset of all functionalities. The applicable functionalities can be reported by the UE.

In model-ID-based LCM, models are identified at the network, and the network/UE may activate/deactivate/select/switch individual AI/ML models via model identifier (ID).

For AI/ML model identification and model-ID-based LCM of UE-side models and/or UE-part of two-sided models, model-ID-based LCM operates based on identified models, where a model may be associated with specific configurations/conditions associated with UE capability of an AI/ML-enabled Feature/FG and additional conditions (e.g., scenarios, sites, and datasets) as determined/identified between UE-side and NW-side.

Along with model identification, mechanisms for UE to report updates on applicable UE part/UE-side model(s) can be used, where the applicable models may be a subset of all identified models. Applicable models can be reported by the UE.

Embodiments can provide means how to handle the impact of UE's internal conditions such as memory, battery, and other hardware limitations on functionality/model operations and AI/ML-enabled features. These methods do not preclude existing solutions.

For functionality/model-ID-based LCM, once functionalities/models are identified, the same or similar procedures may be used for their activation, deactivation, switching, fallback, and monitoring.

A model ID, if needed, can be used in a functionality (defined in functionality-based LCM) for LCM operations.

Different use cases of AI/ML functions/models can include CSI feedback enhancement, beam management, positioning accuracy, and/or other use cases.

In at least some embodiments, the following definitions can be used: AI/ML-enabled Feature: refers to a Feature where AI/ML may be used. AI/ML Functionality: refers to an AI/ML-enabled Feature/FG enabled by configuration(s), where configuration(s) is (are) supported based on conditions indicated by UE. Network-side (AI/ML) model: An AI/ML Model whose inference is performed entirely at the network. UE-side (AI/ML) model: An AI/ML Model whose inference is performed entirely at the UE. Functionality identification: A process/method of identifying an AI/ML functionality for the common understanding between the NW and the UE. Where AI/ML functionality resides depends on the specific use cases and sub use cases. Supported functionalities: As a result of functionality identification, the common understanding of functionalities supported in general is developed between the NW and the UE. The functionalities can be said to be identified or supported. Applicable functionalities: Applicable functionalities can be a subset of supported functionalities. Condition: It can be defined as the criteria comprising details which are specific to the scenario/site/configuration/context for AI/ML functionality. E.g., an AI/ML model for a functionality can be trained for or associated with a ‘condition’, thus, this functionality can be said to be applicable functionality under this ‘condition’. Additional conditions: The conditions which may not included in the above defined “Condition”, that may vary for different scenarios, sites, datasets etc. are defined as additional conditions. E.g., additional conditions can include UE internal conditions such as battery, memory, or other hardware limitations. There can be UE-side conditions and NW-side conditions. Additional conditions of one node (e.g., UE-side additional conditions) may contain private information that is not known to the other node (e.g., gNB) and may not be revealed to the other node (gNB). UE-state: A state of the UE is defined as the UE-state depending on specific UE-side internal/additional conditions and scenario. gNB-state: A state of the gNB is defined as the NW-state depending on specific NW-side additional conditions, scenarios, and configurations. Scenario: A scenario can be defined as a deployment scenario categorized based on different factors such as channel models (heavy line-of-sight (LOS)/non-line of sight (NLOS) conditions, urban microcells (UMi), urban macrocells (UMa), indoor hotspot (InH), and/or other conditions/models), outdoor/indoor UE distributions, carrier frequencies, UE speeds, antenna spacings etc. For example, NW-defined scenarios can be scenarios with NW-defined dataset categorization. UE-defined scenarios can be scenarios with UE-defined dataset categorization. Configuration: The set of configurations can be considered focusing on one of the following aspects: bandwidth, UE speed, antenna port layouts, numerology, etc. Associated ID(s): Identifiers referring to additional conditions, e.g., UE-side additional conditions or NW-side additional conditions may be represented by associated ID(s).

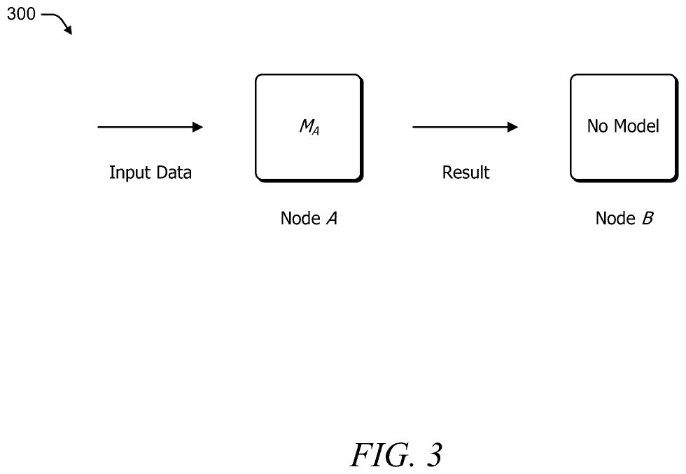

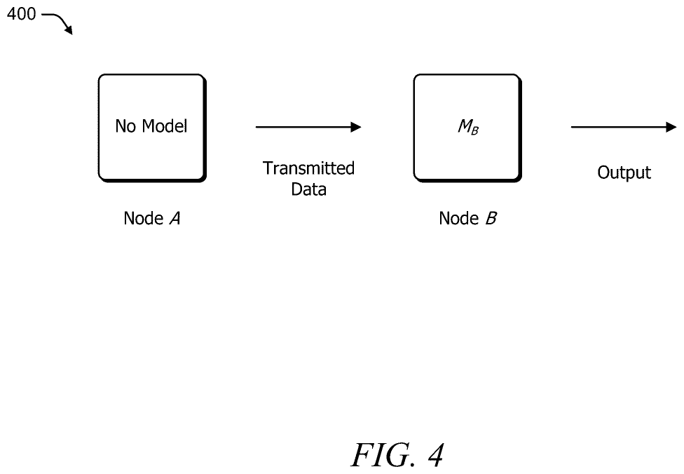

FIG. 3 is an example illustration of a first one-sided model case 300 in accordance with aspects of the present disclosure. The first one-sided model case 300 can be for a Node-A side model. FIG. 4 is an example illustration of a second one-sided model case 400 in accordance with aspects of the present disclosure. The second one-sided model case 400 can be for a Node-B side model. The one-sided model cases 300 and 400 are high-level representations of two cases of one-sided models for use cases such as beam management, CSI prediction, RRM measurement prediction, radio link failure prediction, handover failure prediction, positioning, etc.

Embodiments can focus on one-sided models, in which the AI/ML model is located either at Node A (e.g., UE) or Node B (e.g., gNB) referred to here as M_{A} (model located at Node A) and M_{B} (model located at Node B), respectively. It is noted that the one-sided models are for the sake of illustrations, and Node A/Node B can be either a gBN or a UE.

AI/ML models for a given use case can be tailored toward and applicable to specific scenarios, configurations, locations, and/or deployments, among other factors. In this regard, it is acknowledged that AI/ML models may undergo updates, such as model changes, as an inherent part of their development. After training the models, there can be multiple models (at Node A-side), associated with different Node Bs, and multiple models (at Node B-side) associated with different Node As. Given multiple models for a single functionality, some of which may be scenario or cell-specific, there can be a mechanism for Node A/Node B to select the appropriate model during the inference phase. A suitable model can be selected for the current Node A and Node B state, which can be defined by the additional conditions of the Node A and Node B.

For one-sided AI/ML models, e.g., UE-sided models, it can be assumed that the network has a certain level of control to ensure efficient management (selection, activation, deactivation, switching) of AI/ML models/functionality. This can bring a challenge of coordinating between Node A and Node B to ensure that a suitable model for AI/ML functionality can be selected while ensuring consistent performance. Several embodiments disclose signaling procedures that provide support for the exchange of information among different involved Nodes (e.g., UE and gNB) to allow an appropriate AI/ML model selection for AI/ML functionality. These signaling mechanisms and messages (request/response/report) are not limited to one-sided UE models, and they can be extended for one-sided NW models as well as for two-sided models.

The following abbreviations are considered relevant to the present disclosure.

Table of Abbreviations

| | |
|---|---|
| 3GPP | 3rd generation partnership project |
| 5G | fifth generation |
| 5GS | 5G System |
| 5QI | 5G QoS identifier |
| AI | artificial intelligence |
| AS | access stratum |
| DCI | downlink control information |
| DL | downlink |
| FG | feature group |
| IE | information element |
| KPI | key performance indicator |
| LCG | logical channel group |
| LCM | life cycle management |
| MAC-CE | Medium Access Control Control Element |
| ML | machine learning |
| NW | network |
| QoE | quality of experience |
| QoS | quality of service |
| QCI | QoS class identifier |
| RAN | radio access network |
| RRC | radio resource control |
| RRM | radio resource management |
| SDAP | service data adaptation protocol |
| SIB | system information broadcast |
| UE | user equipment |
| UL | uplink |

In a functionality-based life cycle management (LCM) procedure, the first node (e.g., UE) may only report to the second node (e.g., gNB) about the AI/ML models/functionalities. However, the second node may not be aware of the availability of the potential AI/ML models at the first node applicable for the current scenario or configuration supported by the second node. The second node (gNB) configures the first node for the AI/ML functionality without knowing if there exists an applicable model at the first node for the functionality for the second node. The first node may autonomously select an AI/ML model for the functionality or fall back to legacy operation without coordinating with the second node. This may lead to inefficient performance of the AI/ML-enabled feature/functionality due to the lack of coordination in the two nodes about the supported functionality/configurations/scenarios of AI/ML models.

Embodiments can consider functionality-based LCM for two-sided and one-sided models, i.e., NW-sided AI/ML models and UE-sided AI/ML models. It can be assumed that the data collection for training different AI/ML models has already been performed and the models have been trained at the respective entities. The statistics of training data samples can depend on the type (e.g., NW vendor, chipset vendor) of the two nodes (e.g., Node A and Node B) that are involved during data collection. For a single functionality, multiple models may exist at Node A (e.g., UE) for Node B (e.g., gNB) referring to different configurations, scenarios, and/or NW/UE conditions.

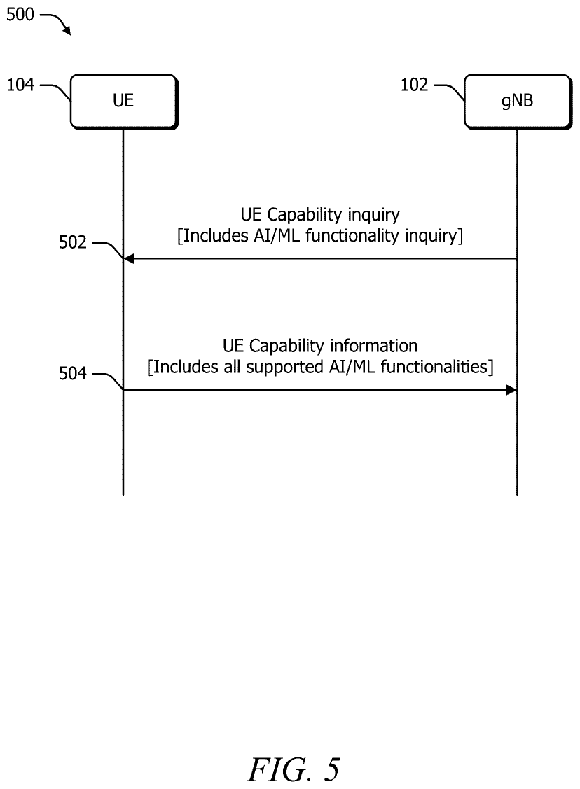

FIG. 5 is an example illustration of a UE capability framework signal flow diagram 500 for AI/ML functionality in accordance with aspects of the present disclosure. The signal flow diagram 500 includes a UE 104 and an NE 102, such as a gNB. At 502, the gNB 102 can send a UE capability inquiry that can include an AI/ML functionality inquiry. At 504, the UE 104 can send capability information that can include at least some or all supported AI/ML functionalities.

According to a possible embodiment, the UE capability framework is extended for AI/ML functionality such that the supported AI/ML functionalities can be reported by a node (e.g., UE) upon a capability inquiry/request from another node (e.g., gNB). An AIML-Parameters for AI/ML specific parameters IE can be used in/with a UE-NR-Capability IE, mainly to indicate the supported AI/ML functionalities in a UE capability report. The capability inquiry can also contain some identifier that represents the type (e.g., NW vendor information) of the first node e.g., gNB, thus ensuring the transparency between the involved nodes (e.g. Node A (UE)/Node B (gNB)). A supported AI/ML functionality can be referred to as the AI/ML functionality for which a node contains one or more AI/ML models and these models may be generalized or cell-specific. This stage can ensure that the UE has an AI/ML model that can be activated for the current gNB/UE state or the current scenario, but in some cases, this step may not be sufficient to ensure that the UE has the model/function that can be activated.

At least some embodiments can provide for a UE-sided AI/ML model. For an applicable AI/ML functionality framework, an applicable AI/ML functionality can be referred to as the AI/ML functionality for which a node contains one or more AI/ML models that are suitable/applicable for the current gNB-state, UE state, and/or a given scenario, such as the current, desired, or other scenario. Applicability of an AI/ML functionality can be defined as the confirmation of supported AI/ML functionality by a second node for the first node, for the current state of both nodes. In other words, functionality can be said to be applicable functionality when it is applicable under the current condition, context scenario, configuration, location, and/or deployment, among other factors).

According to one embodiment, a handshake between the two nodes takes place to enable coordination on the applicable AI/ML functionality and different configurations for functionality for the current state of node A and node B. The second node can provide confirmation of its specific (supported) AI/ML functionality and the available models for different configurations, based on which the first node is aware of the AI/ML functionality applicable and additional conditions by the second node for the first node. The first node may either explicitly request this information from the second node or the second node may proactively report this information to the first node.

At least some embodiments can provide for a UE-sided AI/ML model. For an applicable AI/ML functionality framework, an applicable AI/ML functionality can be referred to as the AI/ML functionality for which a node contains one or more AI/ML models that are suitable for the current gNB-state, UE state, and/or a given scenario, such as the current, desired, or other scenario. Applicability of an AI/ML functionality can be defined as the confirmation of supported AI/ML functionality by a second node for the first node, for the current state of both nodes.

According to one embodiment, a handshake between the two nodes takes place to enable coordination on the applicable AI/ML functionality and different configurations for functionality for the current state of node A and node B. The second node can provide confirmation of its specific (supported) AI/ML functionality and the available models for different configurations, based on which the first node is aware of AI/ML functionality applicable and additional conditions by the second node for the first node. The first node may either explicitly request this information from the second node or the second node may proactively report this information to the first node.

In a possible implementation, the first node, e.g. gNB, explicitly requests a second node, e.g. UE, to provide some indication/information of the applicability of its AI/ML functionality that was sent in the capability report, that the second node, e.g. UE, has a model for specific AI/ML functionality for the first node, e.g. gNB. An AI/ML functionality framework for applicability can be used where the first node, e.g., the gNB, sends an AI/ML applicability request for the supported AI/ML functionality, to the second node, e.g., the UE.

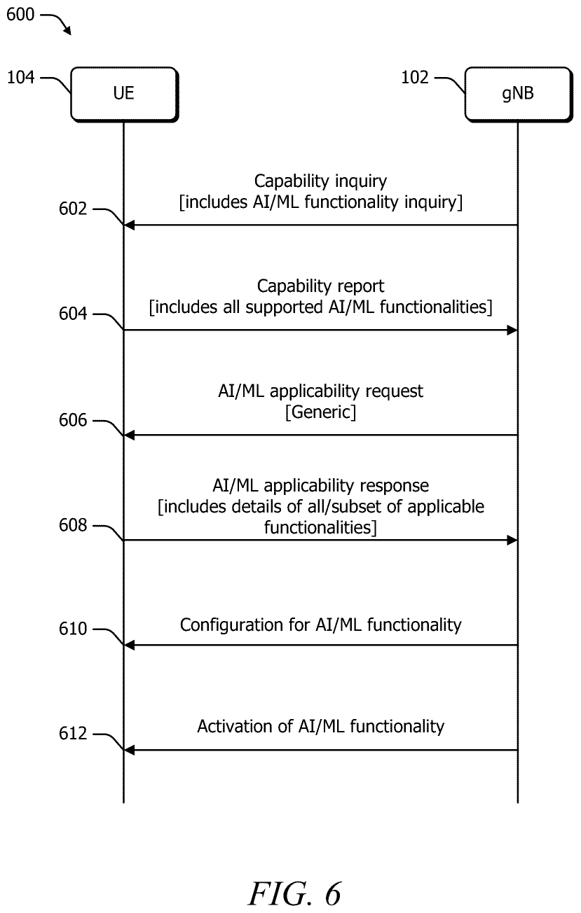

FIG. 6 is an example illustration of a signal flow diagram 600 for an AI/ML applicability request/response in accordance with aspects of the present disclosure. The signal flow diagram 600 includes a UE 104 and an NE 102, such as a gNB. At 602, the gNB 102 can send a capability inquiry that can include an AI/ML functionality inquiry. At 604, the UE 104 can send a capability report that can include at least one, some, or all supported AI/ML functionalities. At 606, the gNB 102 can send an AI/ML applicability request that can be generic. At 608, the UE 104 can send an AI/ML applicability response that can include details of all/subset of applicable functionalities. At 610, the gNB 102 can send a configuration for AI/ML functionality. At 612, the gNB can send an activation of AI/ML functionality. The sending of an activation of AI/ML functionality can be performed in some or all of the other disclosed embodiments. The activation of AI/ML functionality can also be sent as part of the configuration, such as at 610, in this, some, or all disclosed embodiments.

According to one example of the signal flow diagram 600, the first node, e.g., the gNB, sends the AI/ML applicability request asking for information of the applicable functionalities based on the functionalities reported in capability. In response, the second node, e.g., the UE, sends an AI/ML applicability response message that contains a list of all the applicable functionalities including the supported configurations for each functionality. Alternatively, the UE can send a subset of the applicable functionalities and their supported configurations or a subset of configurations for specific functionalities. The identifier that represents the type (e.g., NW vendor information) of the first node, e.g., gNB, can or must be sent either in the capability inquiry or in the applicability request. Thus, the UE can determine the applicability of functionality or applicability of functionality with respect to a specific configuration for a particular gNB, such as a gNB of a particular vendor. In general, determination of the applicability of functionalities can be done by the UE or the NW, depending on the type of AI/ML model (UE-sided or NW-sided) and depending on which node performs the management (selection, switching, fallback etc.) of the AI/ML model.

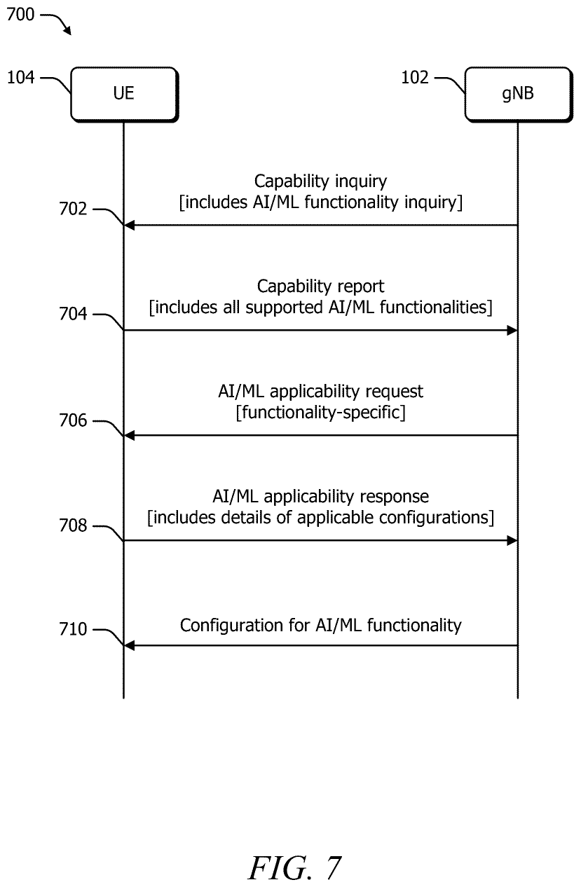

FIG. 7 is an example illustration of a signal flow diagram 700 for an AI/ML applicability request/response in accordance with aspects of the present disclosure. The signal flow diagram 700 includes a UE 104 and an NE 102, such as a gNB. At 702, the gNB 102 can send a capability inquiry that can include an AI/ML functionality inquiry. At 704, the UE 104 can send a capability report that can include at least one, some, or all supported AI/ML functionalities. At 706, the gNB 102 can send an AI/ML applicability request that can be functionality-specific. At 708, the UE 104 can send an AI/ML applicability response that can include details of applicable configurations. At 710, the gNB 102 can send a configuration for AI/ML functionality.

In an implementation of the signal flow diagram 700, the first node, e.g., the gNB, sends the AI/ML applicability request intended for specific functionality. The AI/ML applicability request can contain a configuration for the functionality. To which, the second node, e.g., UE, responds with AI/ML applicability response message which can contain ACK if the requested configuration is supported by the UE, otherwise a NACK with additional information such as the supported parameters from the configuration. Alternatively, if the request message does not contain a specific configuration for the functionality, a UE response message can contain a list of all/subset of the supported configurations for the requested functionality.

A possible implementation can provide for AI/ML applicability request/response. In an example for a generic request, a response can include a list of all applicable functionalities including the specific configurations for each functionality. In another example for a generic request, a response can include a subset of all applicable functionalities including the specific configurations for each of those functionalities or a subset of configurations for specific functionalities. Other examples can provide responses for an AI/ML functionality-specific request. In one example, in response to request for a particular functionality, if the request message does not contain a configuration, the UE can report all/subset of the supported configurations for that functionality. In another example, if the request message contains the required configuration for the functionality, then the UE can report the parameters that it supports for the specific configuration of the functionality requested.

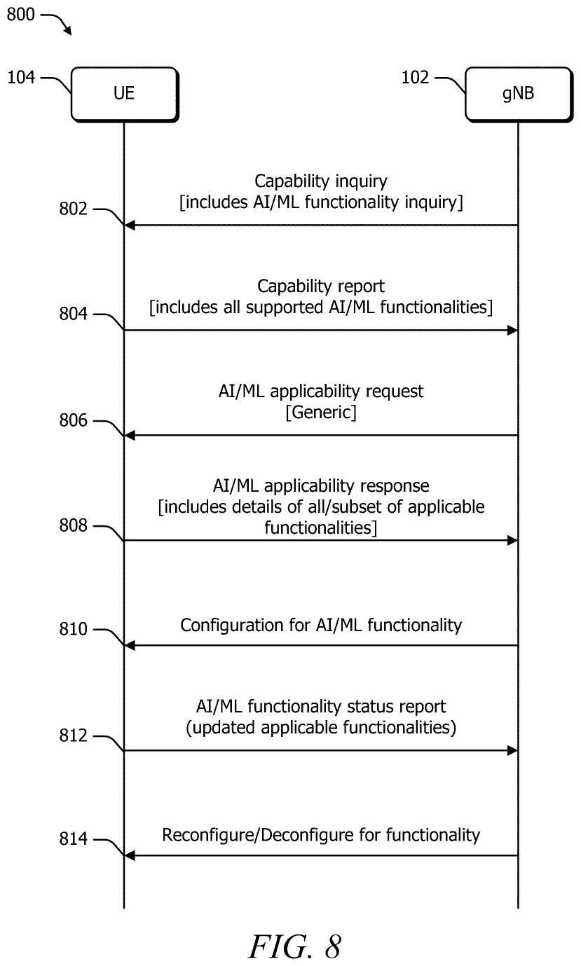

FIG. 8 is an example illustration of signal flow diagram 800 for AI/ML functionality status reporting in accordance with aspects of the present disclosure. The signal flow diagram 800 includes a UE 104 and an NE 102, such as a gNB. At 802, the gNB 102 can send a capability inquiry that can include an AI/ML functionality inquiry. At 804, the UE 104 can send a capability report that can include at least one, some, or all supported AI/ML functionalities. At 806, the gNB 102 can send an AI/ML applicability request that can be generic. At 808, the UE 104 can send an AI/ML applicability response that can include details of all/subset of applicable functionalities. At 810, the gNB 102 can send a configuration for AI/ML functionality. At 812, the UE 104 can send an AI/ML functionality status report with updated applicable functionalities. At 814, the gNB 102 can reconfigure/deconfigure the UE for at least one functionality. In at least one, some, or all embodiments, reconfiguring/deconfiguring can include sending a reconfiguration/deconfiguration, such as in a message or other means to the UE.

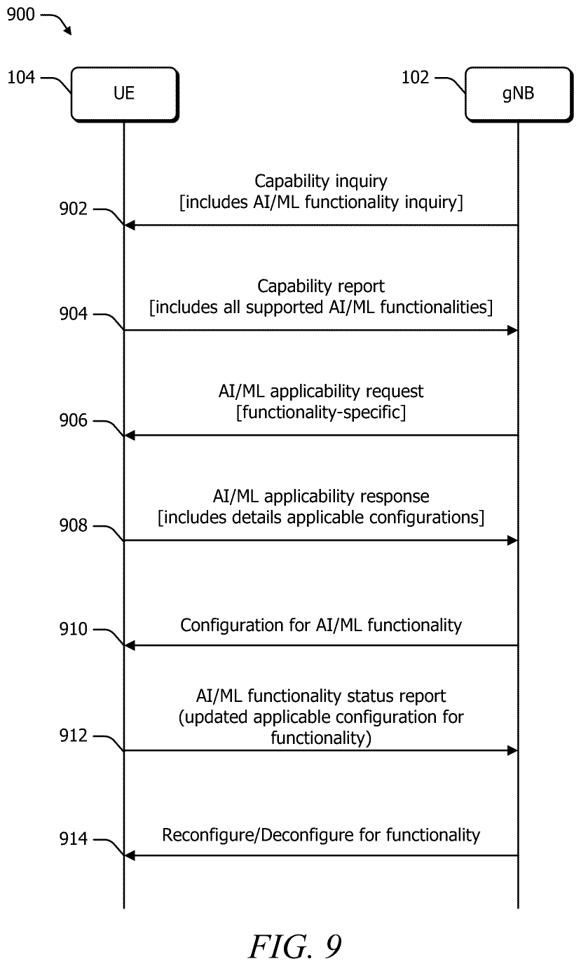

FIG. 9 is an example illustration of signal flow diagram 900 for AI/ML functionality status reporting in accordance with aspects of the present disclosure. The signal flow diagram 900 includes a UE 104 and an NE 102, such as a gNB. At 902, the gNB 102 can send a capability inquiry that can include an AI/ML functionality inquiry. At 904, the UE 104 can send a capability report that can include at least one, some, or all supported AI/ML functionalities. At 906, the gNB 102 can send an AI/ML applicability request that can be functionality-specific. At 908, the UE 104 can send an AI/ML applicability response that can include details for applicable configurations. At 910, the gNB 102 can send a configuration for AI/ML functionality. At 912, the UE 104 can send an AI/ML functionality status report including at least one updated applicable configuration for functionality. At 914, the gNB 102 can reconfigure/deconfigure the UE for at least one functionality.

In a possible implementation of reporting of AI/ML functionality status, a node e.g. UE transmits the current/updated status (e.g., ACK/NACK) of its supported and applicable AI/ML functionality/model to a second node e.g., gNB. The UE can be configured by the gNB to report its status for functionality upon any change in the NW-side conditions/UE-side conditions, any change in the AI/ML model/functionality support, and/or change in scenario. In one alternative, the UE can report an updated list of applicable functionalities for the gNB, as shown in the signal flow diagram 800. In another alternative, the UE can report an updated list of configurations for a specific applicable functionality, as shown in the signal flow diagram 900.

According to one embodiment of an AI/ML applicability report, the second node, e.g., UE, can send a message to the first node, e.g., gNB, to provide information of applicability of its AI/ML functionalities, indicating that the second node, e.g., UE, has models for specific AI/ML functionality/configurations for the first node, e.g., gNB. An additional reporting framework for applicability can be used, in which the second node, e.g., UE, sends the AI/ML applicability report for the applicable AI/ML functionality, to the first node, e.g., gNB.

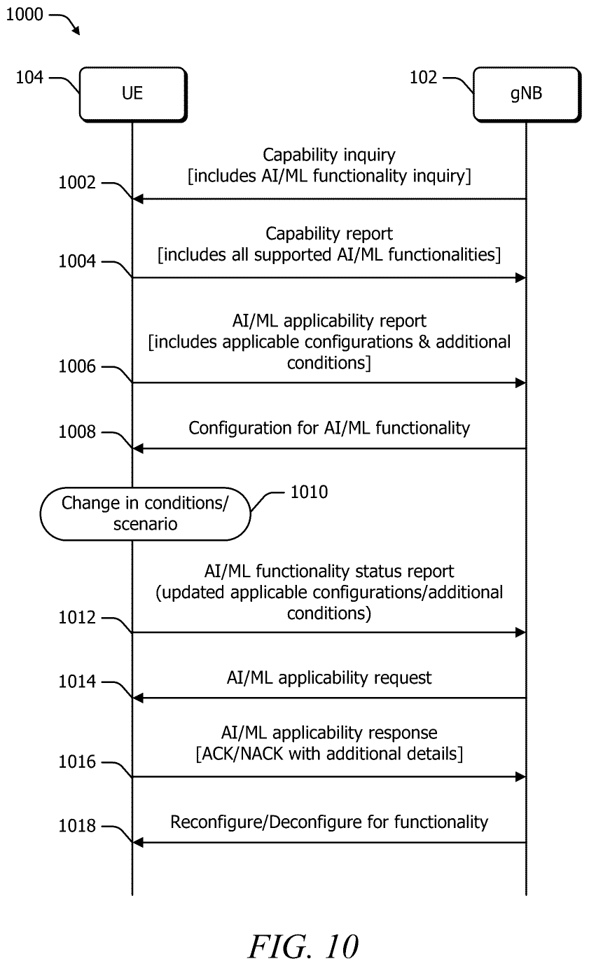

FIG. 10 is an example illustration of a signal flow diagram 1000 for AI/ML applicability reporting in accordance with aspects of the present disclosure. The signal flow diagram 1000 includes a UE 104 and an NE 102, such as a gNB. At 1002, the gNB 102 can send a capability inquiry that can include an AI/ML functionality inquiry. At 1004, the UE 104 can send a capability report that can include at least one, some, or all supported AI/ML functionalities. At 1006, the UE 104 can send an AI/ML applicability report that can include applicable configurations and additional conditions. At 1008, the gNB 102 can send a configuration for AI/ML functionality. At 1010, there can be a change in conditions and/or scenario and the UE 104 can detect the change. At 1012, the UE 104 can send an AI/ML functionality status report including updated applicable configurations/additional conditions. At 1014, the gNB 102 can send an AI/ML applicability request. At 1016, the UE 104 can send an AI/ML applicability response including ACK/NACK with additional details. At 1018, the gNB 102 can reconfigure/deconfigure the UE for at least one functionality.

According to one implementation of the embodiment, as shown in the signal flow diagram 1000, the second node, e.g., UE, sends the AI/ML applicability report providing information of all the applicable functionalities and the supported configurations by the second node for the first node. Alternatively, the second node may send only a subset of the applicable functionalities to the first node (e.g., gNB). If the identifier that represents the type (e.g., NW vendor information) of the first node, e.g., gNB, is provided in the capability inquiry message, then the UE can determine and send the list of applicable configurations for its supported functionalities specifically for the first node (e.g. gNB (vendor)). On the other hand, if the information/identifier of the type (e.g., NW vendor information) of the first node, e.g., gNB, is not provided in the capability inquiry message, the UE can send a list of all configurations for its supported functionalities, which may or may not be applicable to the first node (e.g., gNB). In this case, the first node may send an applicability request message (AI/ML applicability request) that includes the identifier of the type of first node, e.g., gNB, to inquire about the applicability of a specific functionality/configuration. Upon reception of the applicability request, the second node, e.g. UE, determines its AI/ML models for the first node and reports (e.g., ACK/NACK) whether a suitable AI/ML model for the requested configuration is available for the gNB via an AI/ML applicability response message. In another implementation, if the information/identifier of the type (e.g., NW vendor information) of the first node e.g., gNB, is not provided in the capability inquiry message, the UE may not send any proactive applicability report unless an applicability request is received from the first node (gNB). In order to reduce the signaling overhead, the necessary information required to determine the applicability of the models/functionality, such as the identifier of the type of node (e.g., NW vendor), may or must be exchanged in the initial stages for example, in a capability inquiry message. In yet another implementation, if the identifier of the type of the first node is not received by the second node, the second node (e.g., UE) can send a proactive applicability report that contains information (such as a list of configuration(s)) of all applicable functionalities along with the respective identifier of the type of first node. Using this report, the second node (gNB) checks if there are any applicable functionalities for its identifier in the report from the UE, and if present, then it can configure the functionality by sending configuration to the UE.

Followed by the applicability response/report from the UE, the gNB can configure the UE for the supported and applicable AI/ML functionality, such as via RRC configuration. The assumption is that this configuration will not impact the UE's decision to determine the applicability of the AI/ML functionality. Alternatively, the NW can send one or more configurations for a functionality and some switching rule(s). Depending on which the UE may select the AI/ML model for one of the configurations and switch to one of the other configurations based on the switching rule provided by the NW. Identifiers of additional conditions called as associated ID(s) may also be included in the applicability report.

The applicability report from a node (e.g., UE) can be transmitted via a new RRC signaling mechanism. Alternatively, an additional MAC CE can be used for reporting this AI/ML applicability for the supported functionality. In another implementation, the AI/ML applicability report can be sent using a UEAssistanceInformation (UAI) framework.

According to one embodiment for reporting of AI/ML functionality status, a node, e.g. UE, transmits the current/updated status (for e.g., ACK/NACK) of its supported and applicable AI/ML functionality/model that it reported as its capability (UE capability framework) to a second node, e.g., gNB. The UE can be configured by the gNB to report its status in an event-triggered or periodic manner, for example, upon any change in the UE-side conditions or any change in the AI/ML model/functionality support, as illustrated in the signal flow diagram 1000.

In one implementation, the UE triggers the transmission of its status about its supported and applicable AI/ML functionality, upon any change in the UE-side conditions or any change in the AI/ML model/functionality support. For example, the UE can report its AI/ML status as not applicable for specific functionality such as beam management if a relevant AI/ML model for the functionality cannot be activated/applied under current UE battery conditions or updated UE-side/NW-side conditions due to mobility or change in scenario. In another implementation, the AI/ML model/functionality may be updated or new functionality may become applicable for the gNB (for example, due to handover). In this case, the UE can report an updated/new list of functionalities or configurations for a functionality, that are now applicable for the gNB. In response to the status report, the gNB can send an applicability request depending on what information is shared in the status report or the gNB can directly (re) configure the UE based on the received status report for a functionality.

In one implementation, additional RRC signaling can be used by the UE to report the UE status for a specific AI/ML functionality, if configured by the NW either with periodic reporting or event-triggered reporting.

In another implementation, the AI/ML functionality report can be sent using a UEAssistanceInformation (UAI) framework. An additional AIML-Assistance IE can be extended to include the status reports for different AI/ML features, such as beamManagementAIML-status, positioningAIML-status, etc. The reporting using UAI can provide for flexibility for the UE to transmit its AI/ML functionality status depending on its condition change or any model change/update. Furthermore, this IE can also contain parameters describing UE-side additional conditions relevant for AI/ML functionalities, for instance, using an additional IE, such as a UEAdditionalConditions-r19 IE.

According to a possible implementation, the UE can send all or a subset of the applicable configurations in an AI/ML applicability report. If an identifier of the type of node (e.g., proxyID for vendor information) is included in the capability inquiry, UE can send all applicable configurations for its supported functionalities. If an identifier (e.g., proxyID) is not included in the capability inquiry, in one example, the UE can send all the configurations in general for all its supported functionalities, not specific to the current gNB, as it is not aware of the identifier of the node (gNB vendor). In another example, the UE may not send the applicability report.

At least some embodiments can provide for a NW-sided AI/ML model(s).

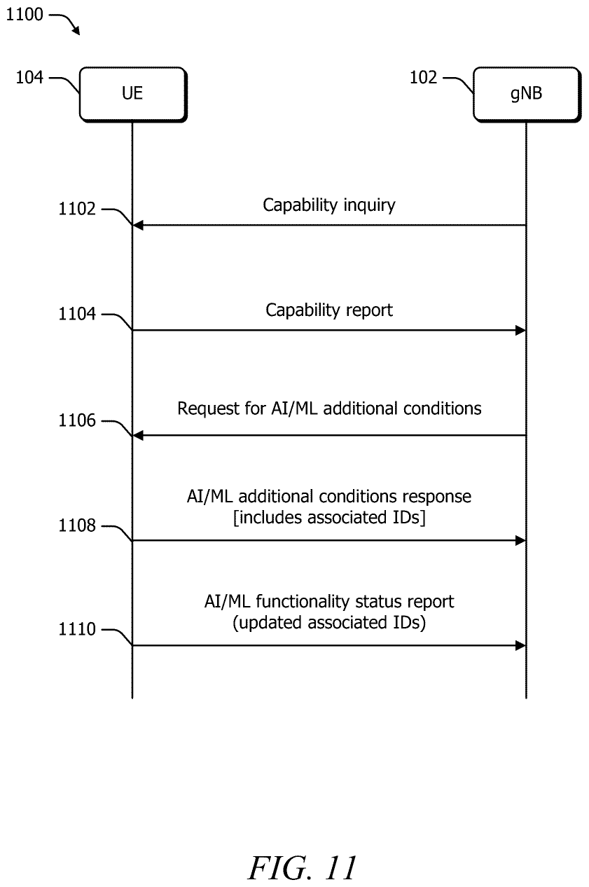

FIG. 11 is an example illustration of a signal flow diagram 1100 for request/response of additional conditions for a NW-sided AI/ML model in accordance with aspects of the present disclosure. The signal flow diagram 1100 includes a UE 104 and an NE 102, such as a gNB. At 1102, the gNB 102 can send a capability inquiry. At 1104, the UE 104 can send a capability report. At 1106, the gNB 102 can send a request for AI/ML additional conditions. At 1108, the UE 104 can send an AI/ML additional conditions response that can include associated IDs. At 1110, the UE 104 can send an AI/ML functionality status report that can include updated associated IDs.

According to one embodiment, the first node, e.g., gNB sends an identifier (e.g., vendor information) indicating the type of the first node, to the second node, e.g., UE. In one implementation, such an identifier can be transmitted in the capability inquiry message by the first node (gNB). Alternatively, an identifier of the type of node may be included in an additional message (e.g., a request for AI/ML additional conditions) from the gNB to the UE. It can be implemented using an additional RRC message, an additional MAC CE, in a DCI, and/or any other suitable implementation.

In another implementation, the first node, e.g., gNB sends a message, Request for AI/ML additional conditions, requesting information of the UE-side additional conditions represented with associated ID(s). If an identifier of the type of node was not provided in an earlier message such as a capability inquiry message, the Request for AI/ML additional conditions message can also include the identifier of a type of the first node (gNB). This request for additional conditions may either be generic or functionality-specific. For the functionality-specific request, the message may include some indicator(s) of the requested functionality. In response to this message, the second node (UE) sends a message, AI/ML additional conditions response, that includes a list of its associated ID(s) (representing for example additional conditions for which the AI/ML models for a functionality are trained) for the first node (gNB). If a functionality-specific request was received by the second node, the response message contains a list of associated ID(s) for that functionality for the gNB. In another implementation, the reported associated ID(s) by the UE may or may not related to the specific gNB. For example, the UE may not be aware of the type of gNB. In this case, the UE may send all the associated ID(s) and the gNB may be capable of recognizing its associated ID(s) among the ones received. Information about the UE-side additional conditions may support the NW to select a suitable AI/ML model for a functionality.

According to one embodiment, a node, e.g., UE, transmits the current/updated status of its associated ID(s) for the AI/ML functionality requested in an earlier request, to a second node, e.g., gNB. In case the AI/ML model/functionality is updated including a change in internal/additional conditions, then the UE may inform the updated information to the NW. The UE can be configured by the gNB to report its status, which includes the associated ID(s), in an event-triggered or periodic manner, for example, upon any change in the UE-side conditions or any change in the AI/ML model/functionality support.

For two-sided AI/ML models, both the mechanisms for the UE-sided model and the NW-sided model can be combined. The UE part of the two-sided model can follow the applicability framework illustrated above for the UE-sided model and the NW part of the two-sided model can follow the message exchange sequence of the NW-sided model.

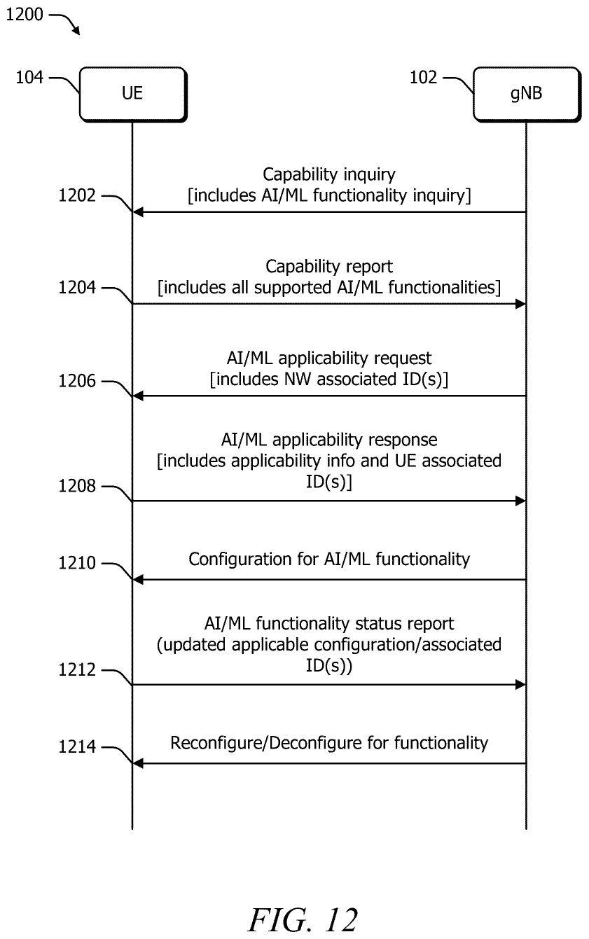

FIG. 12 is an example illustration of a signal flow diagram 1200 for reporting of applicability and additional conditions for a two-sided AI/ML model in accordance with aspects of the present disclosure. The signal flow diagram 1200 includes a UE 104 and an NE 102, such as a gNB. At 1202, the gNB 102 can send a capability inquiry that can include an AI/ML functionality inquiry. At 1204, the UE 104 can send a capability report that can include at least one, some, or all supported AI/ML functionalities. At 1206, the gNB 102 can send an AI/ML applicability request that includes network-associated ID(s). At 1208, the UE 104 can send an AI/ML applicability response that includes applicability info and UE-associated ID(s). At 1210, the gNB 102 can send a configuration for AI/ML functionality. At 1212, the UE 104 can send an AI/ML functionality status report that can include updated applicable configuration/associated ID(s). At 1214, the gNB 102 can reconfigure/deconfigure the UE for at least one functionality.

According to one embodiment, the first node, e.g. gNB, explicitly requests a second node, e.g. UE, to provide some indication/information of the applicability of its AI/ML functionality that was sent in the capability report, that the second node, e.g. UE, has a model for specific AI/ML functionality for the first node, e.g. gNB. An additional AI/ML functionality framework for applicability can be used, in which the first node, e.g., the gNB, sends a request for the supported AI/ML functionality, to the second node, e.g., the UE.

According to one implementation shown in the diagram 1200, the first node, e.g., the gNB, sends the AI/ML applicability request asking for information of the applicable functionalities based on the functionalities reported in the capability report. The applicability request can also include the associated ID(s) referring to NW-side additional conditions. Additionally, the applicability request can contain a request to report the UE-side additional conditions in the form of associated ID(s). In response, the second node, e.g., the UE, sends an AI/ML applicability response message that contains an ACK/NACK for the requested functionalities or it may contain a list of all the applicable functionalities including the supported configurations for each functionality or a specific functionality. Alternatively, in the applicability response message, the UE can also send the associated ID(s) for a functionality, indicating the applicability of its AI/ML models trained with specific UE-side associated ID(s) for the NW-side associated ID(s) (received as part of the applicability request). In another implementation, the gNB and UE can exchange their respective additional conditions (associated ID(s)), and then the gNB requests applicability for a specific configuration of a functionality. In response to this, the UE sends information of the applicability of the configuration. For the case when more than one configuration for a functionality is sent by the UE, the gNB may select a suitable configuration (assuming it may have received the UE-side associated ID(s)).

In another implementation, UE can report its applicable functionalities and respective configurations for the gNB proactively, without receiving any applicability request, such as described above for the UE-sided model.

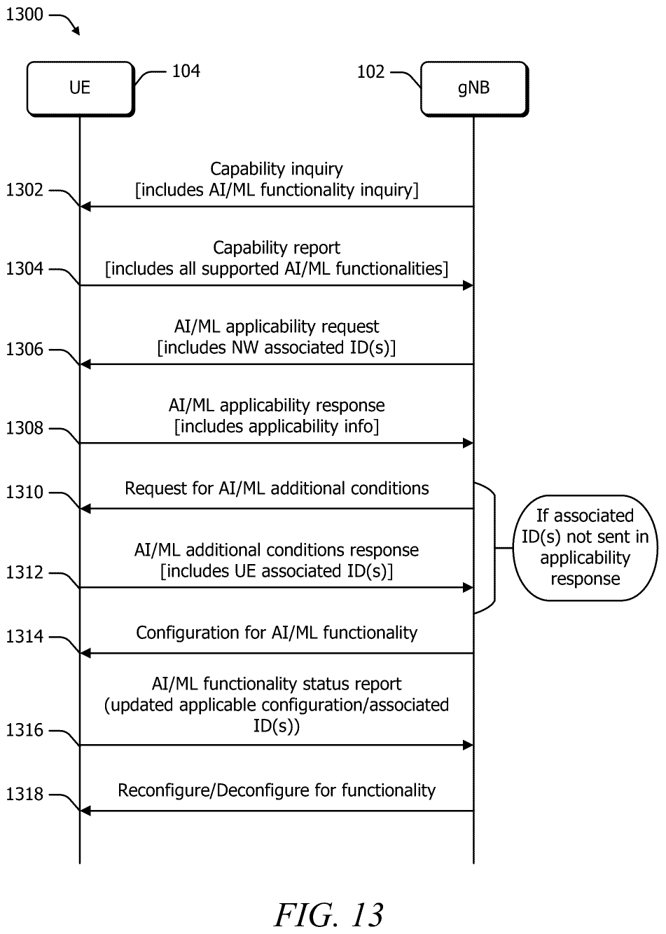

FIG. 13 is an example illustration of a signal flow diagram 1300 for reporting of applicability and additional conditions for a two-sided AI/ML model in accordance with aspects of the present disclosure. The signal flow diagram 1300 includes a UE 104 and an NE 102, such as a gNB. At 1302, the gNB 102 can send a capability inquiry that can include an AI/ML functionality inquiry. At 1304, the UE 104 can send a capability report that can include at least one, some, or all supported AI/ML functionalities. At 1306, the gNB 102 can send an AI/ML applicability request that can include network-associated ID(s). At 1308, the UE 104 can send an AI/ML applicability response that can include applicability information. At 1310, the gNB 102 can send a request for AI/ML additional conditions. At 1312, the UE 104 can send an AI/ML additional conditions response that can include UE-associated ID(s). The operations of 1310 and 1312 can be performed if associated ID(s) is/are not sent in the applicability response. At 1314, the gNB 102 can send a configuration for AI/ML functionality. At 1316, the UE 104 can send an AI/ML functionality status report that can include updated applicable configuration/associated ID(s). At 1318, the gNB 102 can send a reconfigure/deconfigure message for at least one functionality.

According to one embodiment, the first node, e.g., the gNB, sends the AI/ML applicability request asking for information of the applicable functionalities based on the functionalities reported in the capability report and the NW-side additional conditions. In one implementation, the applicability request contains the associated ID(s) referring to NW-side additional conditions. A request for UE-side additional conditions may not be included in the applicability request. In response to the applicability request, the UE sends the information of applicable functionalities and can also include the applicable configurations for functionalities. As the applicability response message may not contain associated ID(s) for UE-side additional conditions, the gNB can explicitly send a request message (request for AI/ML additional conditions) to inquire about the additional conditions from the UE. To which, the UE sends its associated ID(s) for the gNB in a response message (AI/ML additional conditions response).

In one implementation, these request/response messages can be transmitted as additional RRC signaling. In another implementation, an additional MAC or DCI can be used to transmit/receive the messages for additional conditions (Request for AI/ML additional conditions and AI/ML additional conditions response). In yet another implementation, the response message can be sent using a UE assistance information framework.

According to one embodiment, a source gNB provides during mobility (e.g. handover) AI/ML-related information of the UE to the target gNB. According to one implementation of the embodiment, the source gNB provides AI/ML-related identifier(s) of the UE to the target gNB during the handover preparation phase. In one example, the source gNB provides some indication of the supported and/or applicable functionality/models of the UE to the target gNB. In order to allow the target gNB to select/activate a specific AI/ML functionality/model after the handover, according to this embodiment, the target gNB can be provided with the AI/ML-related identifiers. In one example, the source gNB requests the UE to provide the identifier(s), such as an indication of applicable functionality/model and/or additional conditions, for a specific gNB. In response to this request, the UE can provide information about the applicability of one or more configurations for one or more supported functionalities for the target gNB. The source gNB can forward this information to the target gNB. In one example, the information is included in the handover request (HO REQUEST) message. The source gNB requesting the AI/ML identifier(s)/information and corresponding UE response message may be sent before the handover request message.

At least some embodiments can provide UE-sided models. A possible implementation can provide an applicable AI/ML functionality framework. A handshake mechanism can provide for request/response of the applicability of a specific AI/ML functionality. For example, the network sends a request to the UE, AI/ML applicability request, to inquire about the applicability of the AI/ML functionality/model and the configurations. The applicability request may be a generic request or a functionality-specific request. The UE sends a response, AI/ML applicability response, providing information about the supported configurations for an applicable AI/ML functionality. In an example, the UE sends a list of configurations for all applicable functionalities for the gNB. In a further example, the UE sends a list of configurations for the specific functionality requested by the gNB. The NW configures the UE for the AI/ML functionality after receiving an acknowledgment or it can reconfigure/deconfigure the UE for this AI/ML functionality.

A possible implementation can provide applicability reporting. For example, the UE proactively reports its applicability of AI/ML functionality to the NW, including additional details such as a list of all or a subset of applicable configurations for the functionality. The NW configures the UE for one of the applicable configurations or it can send another applicability request for a specific functionality. The UE can send an update about the configurations and the applicability of AI/ML functionality in a status report message.

At least some embodiments can provide NW-sided models. A possible implementation can provide signaling for additional conditions. For example, a request/response message sequence can provide information such as UE-side additional conditions, which can support the NW in choosing a suitable AI/ML model. Additional conditions can be sent by the UE in the form of associated ID(s).

At least some embodiments can provide NW-sided models where a combination of UE-sided and NW-sided signaling exchanges NW-sided conditions for the UE-side part and UE-sided conditions for the NW-side part or both.

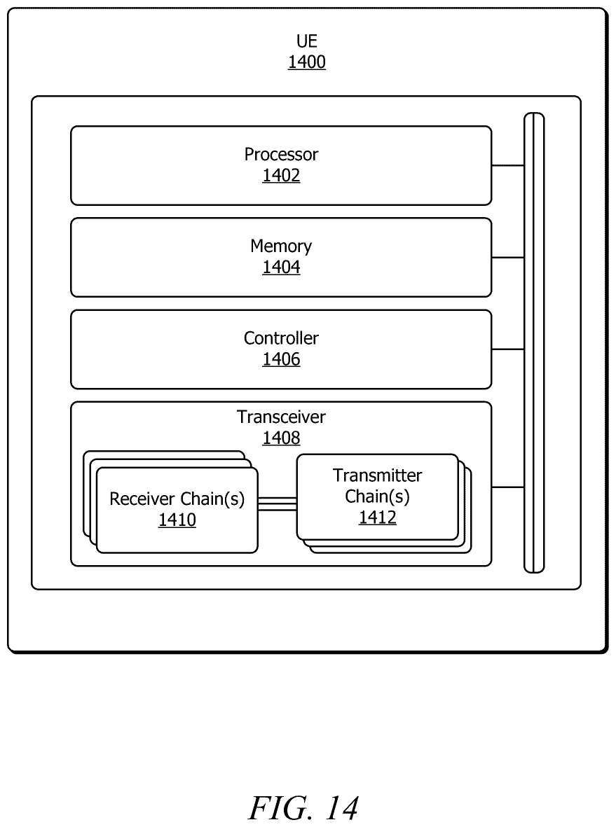

FIG. 14 illustrates an example of a UE 1400 in accordance with aspects of the present disclosure. The UE 1400 may include at least one processor 1402, at least one memory 1404, at least one controller 1406, and at least one transceiver 1408. The processor 1402, the memory 1404, the controller 1406, the transceiver 1408, various combinations thereof, or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, the transceiver 1408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1402 may include an intelligent hardware device (e.g., a general-purpose processor, a DSP, a central processing unit (CPU), an ASIC, a field programmable gate array (FPGA), or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the UE 1400 to perform various functions of the present disclosure.

The memory 1404 may include volatile or non-volatile memory. The memory 1404 may store computer-readable, computer-executable code including instructions when executed by the processor 1402 cause the UE 1400 to perform various functions described herein. The code may be stored in a non-transitory computer-readable medium such the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

The controller 1406 may manage input and output signals for the UE 1400. The controller 1406 may also manage peripherals not integrated into the UE 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the UE 1400 may include at least one transceiver 1408. In some other implementations, the UE 1400 may have more than one transceiver 1408. The transceiver 1408 may represent a wireless transceiver. The transceiver 1408 may also represent and/or include one or more other wireless and or wired communication interfaces, such as a network interface, a universal serial bus (USB) port, an optical transceiver, and/or any other transceiver, interface, port, communication interface, etc. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas for receiving the signal over the air or wireless medium. The receiver chain 1410 may include at least one amplifier (e.g., a low-noise amplifier (LNA)) configured to amplify the received signal. The receiver chain 1410 may include at least one demodulator configured to demodulate the received signal and obtain the transmitted data by reversing the modulation technique applied during transmission of the signal. The receiver chain 1410 may include at least one decoder for decoding the processing the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more modulation techniques such as amplitude modulation (AM), frequency modulation (FM), digital modulation schemes like phase-shift keying (PSK) or quadrature amplitude modulation (QAM), and/or any other modulation techniques. The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

In some implementations, the processor 1402 and the memory 1404 coupled with the processor 1402 may be configured to cause the UE 1400 to perform one or more of the functions described herein (e.g., executing, by the processor 1402, instructions stored in the memory 1404). For example, the processor 1402 may support wireless communication at the UE 1400 in accordance with the examples as disclosed herein.

The UE 1400 can be configured to support a means for communicating AI/ML information. In operation according to a possible embodiment, the at least one processor 1402 can be configured to cause the UE 1400 to receive, from a network entity, a request message for information associated with AI. The at least one processor 1402 can be configured to cause the UE 1400 to transmit, to the network entity, a response message including applicability-related information associated with at least one AI functionality supported by the UE based at least in part on the received request message.

AI can include ML. Thus, the request can be for information associated with AI/ML. AI functionalities can include AI functionalities and/or models, such as one or more models for a functionality. In some examples, the request message may be referred to as an AI-related message including a request for AI assistance information (AI applicability-related information), such as AI functionalities supported by the UE, etc. The request message can include an AI IE requesting the AI applicability-related information.

According to a possible implementation, the request message can include at least one identifier of network assistance information associated with AI. The network assistance information can include one or more of an identifier of a type of a node of the network entity, one or more parameters of the network entity, and/or a name of the network entity.

According to a possible implementation, the request message can include an inquiry for a set of conditions associated with the at least one AI functionality. The response message can indicate one or more conditions associated with the at least one AI functionality based at least in part on the inquiry for the set of conditions associated with the at least one AI functionality. In a possible example, the one or more conditions can include at least one selected from a memory condition of the UE, a battery condition of the UE, and hardware limitations of the UE for an AI-enabled feature.

According to a possible implementation, the response message includes one or more of: a subset of AI functionalities of a set of AI functionalities supported by the UE, a set of one or more configurations associated with the at least one AI functionality, and/or at least one identifier of at least one condition associated with at least one AI functionality. According to a possible implementation, the information associated with AI indicates an applicability of the at least one AI functionality supported by the UE, where the applicability of the at least one AI functionality supported by the UE is based at least in part on an identifier of a type of node or a condition, and where the identifier is received in the request message.

According to a possible implementation, the at least one processor 1402 is configured to cause the UE 1400 to receive at least a subset of a first configuration associated with the at least AI functionality, and/or an indication to activate a second configuration associated with the at least AI functionality. According to a possible implementation, the request message can be a UE capability request message and the response message can be a UE capability response message.

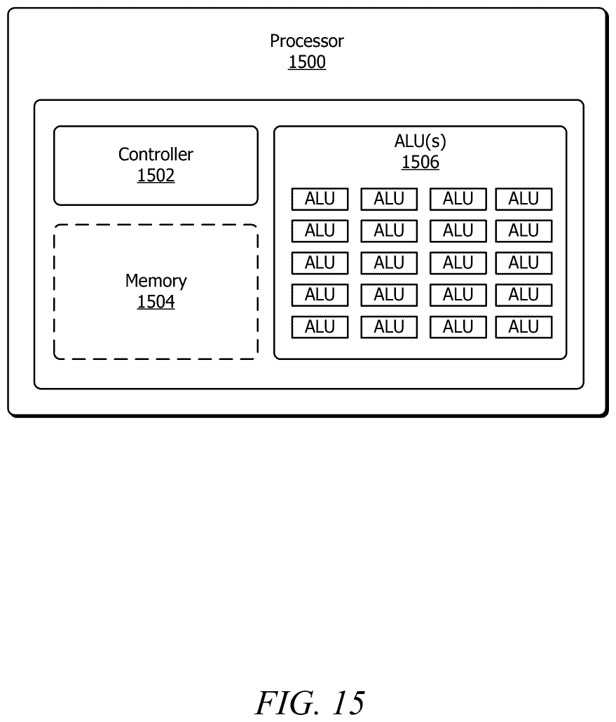

FIG. 15 illustrates an example of a processor 1500 in accordance with aspects of the present disclosure. The processor 1500 may be an example of a processor configured to perform various operations in accordance with the examples described herein. The processor 1500 may include at least one controller 1502 configured to perform various operations in accordance with the examples described herein. The processor 1500 may optionally include at least one memory 1504, which may be, for example, an L1/L2/L3 cache. Additionally, or alternatively, the processor 1500 may optionally include one or more arithmetic-logic units (ALUs) 1506. One or more of these components may be in electronic communication or otherwise coupled (e.g., operatively, communicatively, functionally, electronically, electrically) via one or more interfaces (e.g., buses).

The processor 1500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1500)) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1502 may be configured to manage and coordinate various operations (e.g., signaling, receiving, obtaining, retrieving, transmitting, outputting, forwarding, storing, determining, identifying, accessing, writing, reading) of the processor 1500 to cause the processor 1500 to support various operations in accordance with examples as described herein. For example, the controller 1502 may operate as a control unit of the processor 1500, generating control signals that manage the operation of various components of the processor 1500. These control signals include enabling or disabling functional units, selecting data paths, initiating memory access, and coordinating the timing of operations.

The controller 1502 may be configured to fetch (e.g., obtain, retrieve, receive) instructions from the memory 1504 and determine subsequent instruction(s) to be executed to cause the processor 1500 to support various operations in accordance with examples as described herein. The controller 1502 may be configured to track memory addresses of instructions associated with the memory 1504. The controller 1502 may be configured to decode instructions to determine the operation to be performed and the operands involved. For example, the controller 1502 may be configured to interpret the instruction and determine control signals to be output to other components of the processor 1500 to cause the processor 1500 to support various operations in accordance with examples as described herein. Additionally, or alternatively, the controller 1502 may be configured to manage the flow of data within the processor 1500. The controller 1502 may be configured to control the transfer of data between registers, ALUs, and other functional units of the processor 1500.

The memory 1504 may include one or more caches (e.g., memory local to or included in the processor 1500 or other memory, such RAM, ROM, DRAM, SDRAM, SRAM, MRAM, flash memory, etc. In some implementations, the memory 1504 may reside within or on a processor chipset (e.g., local to the processor 1500). In some other implementations, the memory 1504 may reside external to the processor chipset (e.g., remote to the processor 1500).

The memory 1504 may store computer-readable, computer-executable code including instructions that, when executed by the processor 1500, cause the processor 1500 to perform various functions described herein. The code may be stored in a non-transitory computer-readable medium such as system memory or another type of memory. The controller 1502 and/or the processor 1500 may be configured to execute computer-readable instructions stored in the memory 1504 to cause the processor 1500 to perform various functions. For example, the processor 1500 and/or the controller 1502 may be coupled with or to the memory 1504, the processor 1500, the controller 1502, and the memory 1504 may be configured to perform various functions described herein. In some examples, the processor 1500 may include multiple processors and the memory 1504 may include multiple memories. One or more of the multiple processors may be coupled with one or more of the multiple memories, which may, individually or collectively, be configured to perform various functions herein.

The one or more ALUs 1506 may be configured to support various operations in accordance with examples as described herein. In some implementations, the one or more ALUs 1506 may reside within or on a processor chipset (e.g., the processor 1500). In some other implementations, the one or more ALUs 1506 may reside external to the processor chipset (e.g., the processor 1500). One or more ALUs 1506 may perform one or more computations such as addition, subtraction, multiplication, and division on data. For example, one or more ALUs 1506 may receive input operands and an operation code, which determines an operation to be executed. One or more ALUs 1506 be configured with a variety of logical and arithmetic circuits, including adders, subtractors, shifters, and logic gates, to process and manipulate the data according to the operation. Additionally, or alternatively, the one or more ALUs 1506 may support logical operations such as AND, OR, exclusive-OR (XOR), not-OR (NOR), and not-AND (NAND), enabling the one or more ALUs 1506 to handle conditional operations, comparisons, and bitwise operations.

The processor 1500 may support wireless communication in accordance with examples as disclosed herein. The processor 1500 may be configured to or operable to support a means for communicating AI/ML information.

In operation according to a possible embodiment, the at least one controller 1502 can be configured to cause the processor 1500 to receive, from a network entity, a request message for information associated with AI. The at least one controller 1502 can be configured to cause the processor 1500 to transmit, to the network entity, a response message including applicability-related information associated with at least one AI functionality supported by a UE based at least in part on the received request message.

According to a possible implementation, the request message can include at least one identifier of network assistance information associated with AI. The network assistance information can include one or more of an identifier of a type of a node of the network entity, one or more parameters of the node of the network entity, and/or a name of the node of the network entity.

According to a possible implementation, the request message can include an inquiry for a set of conditions associated with the at least one AI functionality. The response message can indicate one or more conditions associated with the at least one AI functionality based at least in part on the inquiry for the set of conditions associated with the at least one AI functionality.

According to a possible implementation, the information associated with AI can indicate an applicability of the at least one AI functionality supported by the UE. The applicability of the at least one AI functionality supported by the UE can be based at least in part on an identifier of a type of node or a condition. The identifier can be received in the request message.

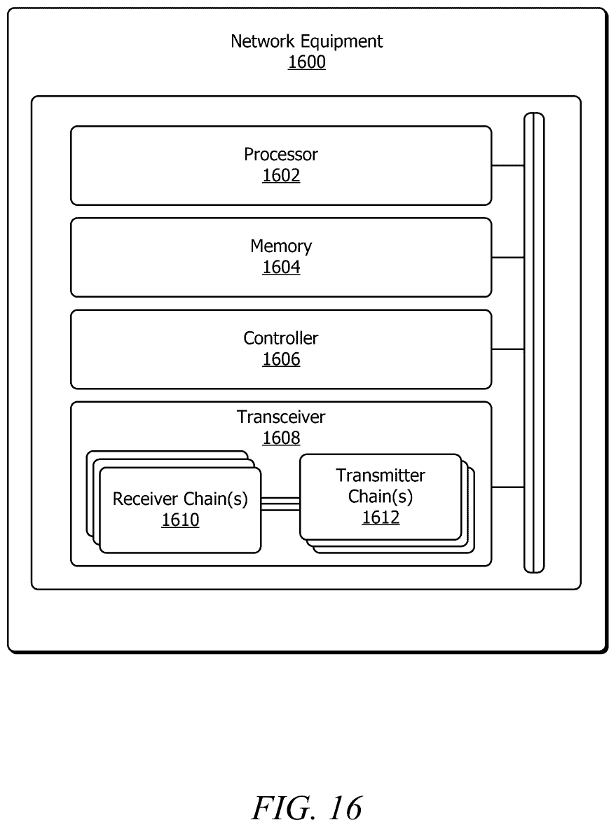

FIG. 16 illustrates an example of an NE 1600, such as a base station, in accordance with aspects of the present disclosure. The NE 1600 may include at least one processor 1602, at least one memory 1604, at least one controller 1606, and at least one transceiver 1608. The processor 1602, the memory 1604, the controller 1606, the transceiver 1608, or various combinations thereof or various components thereof may be examples of means for performing various aspects of the present disclosure as described herein. These components may be coupled (e.g., operatively, communicatively, functionally, electronically, electrically) via one or more interfaces.

The processor 1602, the memory 1604, the controller 1606, the transceiver 1608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1602 may include an intelligent hardware device (e.g., a general-purpose processor, a DSP, a CPU, an ASIC, an FPGA, or any combination thereof). In some implementations, the processor 1602 may be configured to operate the memory 1604. In some other implementations, the memory 1604 may be integrated into the processor 1602. The processor 1602 may be configured to execute computer-readable instructions stored in the memory 1604 to cause the NE 1600 to perform various functions of the present disclosure.

The memory 1604 may include volatile or non-volatile memory. The memory 1604 may store computer-readable, computer-executable code including instructions when executed by the processor 1602 cause the NE 1600 to perform various functions described herein. The code may be stored in a non-transitory computer-readable medium such the memory 1604 or another type of memory. Computer-readable media includes both non-transitory computer storage media and communication media including any medium that facilitates the transfer of a computer program from one place to another. A non-transitory storage medium may be any available medium that may be accessed by a general-purpose or special-purpose computer.

The controller 1606 may manage input and output signals for the NE 1600. The controller 1606 may also manage peripherals not integrated into the NE 1600. In some implementations, the controller 1606 may utilize an operating system such as iOS®, ANDROID®, WINDOWS®, or other operating systems. In some implementations, the controller 1606 may be implemented as part of the processor 1602.

In some implementations, the NE 1600 may include at least one transceiver 1608. In some other implementations, the NE 1600 may have more than one transceiver 1608. The transceiver 1608 may represent at least one wireless transceiver and may include other transceivers, such as a wired transceiver, like a network interface. The transceiver 1608 may include one or more receiver chains 1610, one or more transmitter chains 1612, or a combination thereof.

A receiver chain 1610 may be configured to receive signals (e.g., control information, data, packets) over a wireless medium. For example, the receiver chain 1610 may include one or more antennas for receiving the signal over the air or wireless medium. The receiver chain 1610 may include at least one amplifier (e.g., a LNA) configured to amplify the received signal. The receiver chain 1610 may include at least one demodulator configured to demodulate the received signal and obtain the transmitted data by reversing the modulation technique applied during the transmission of the signal. The receiver chain 1610 may include at least one decoder for decoding the processing the demodulated signal to receive the transmitted data.

A transmitter chain 1612 may be configured to generate and transmit signals (e.g., control information, data, packets). The transmitter chain 1612 may include at least one modulator for modulating data onto a carrier signal, preparing the signal for transmission over a wireless medium. The at least one modulator may be configured to support one or more modulation techniques such as AM, FM, or digital modulation schemes like PSK or QAM, and/or any other modulation techniques. The transmitter chain 1612 may also include at least one power amplifier configured to amplify the modulated signal to an appropriate power level suitable for transmission over the wireless medium. The transmitter chain 1612 may also include one or more antennas for transmitting the amplified signal into the air or wireless medium.

In some implementations, the processor 1602 and the memory 1604 coupled with the processor 1602 may be configured to cause the NE 1600 to perform one or more of the functions described herein (e.g., executing, by the processor 1602, instructions stored in the memory 1604). For example, the processor 1602 may support wireless communication at the NE 1600 in accordance with examples as disclosed herein.

The NE 1600 may be configured to support a means for communicating AI/ML information.

In operation the NE 1600 (e.g., a base station or other network entity as described herein with reference to FIG. 1) according to a possible embodiment, the at least one processor 1602 can be configured to cause the NE 1600 to transmit, to a UE, a request message for information associated with AI. The at least one processor 1602 can be configured to cause the NE 1600 to receive, from the UE, a response message including applicability-related information associated with at least one AI functionality supported by the UE based at least in part on the received request message.

According to a possible implementation, the request message can include at least one identifier of network assistance information associated with AI. The network assistance information can include one or more of an identifier of a type of a node of the NE 1600, one or more parameters of the NE 1600, or a name of the NE 1600.

According to a possible implementation, the request message can include an inquiry for a set of conditions associated with the at least one AI functionality. The response message can indicate one or more conditions associated with the at least one AI functionality based at least in part on the inquiry for the set of conditions associated with the at least one AI functionality.

According to a possible implementation, the information associated with AI indicates an applicability of the at least one AI functionality supported by the UE. The applicability of the at least one AI functionality supported by the UE can be based at least in part on an identifier of a type of node or a condition. The identifier can be received in the request message.

According to a possible implementation, the at least one processor 1602 can be configured to cause the NE 1600 to send applicability-related information for at least one AI functionality to at least one network entity other than the NE 1600.

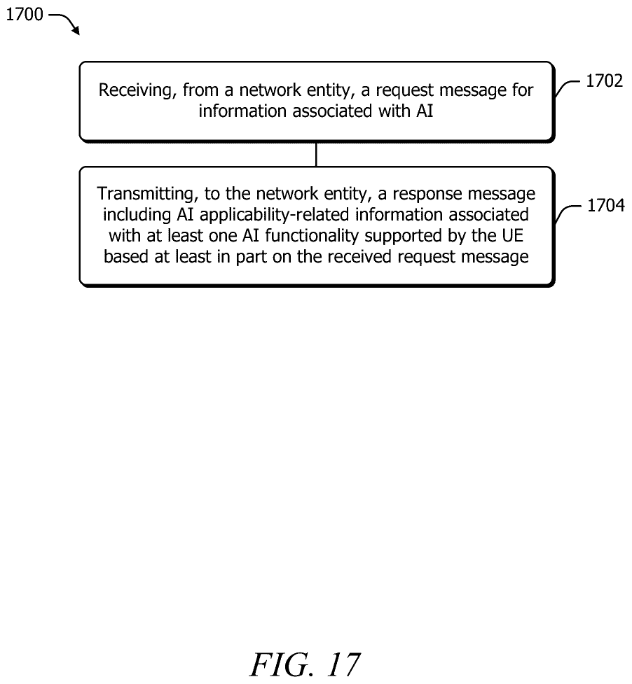

FIG. 17 illustrates a flowchart 1700 of a method in accordance with aspects of the present disclosure. The operations of the method may be implemented by a UE as described herein. In some implementations, the UE may execute a set of instructions to control the function elements of the UE to perform the described functions. Each operation of the flowchart 1700 may be performed in accordance with the examples described herein. In some implementations, aspects of particular operations may be performed by a UE 1400 as described with reference to FIG. 14.

At 1702, the method can include receiving, from a network entity, a request message for information associated with AI. At 1704, the method can include transmitting, to the network entity, a response message including applicability-related information associated with at least one AI functionality supported by the UE based at least in part on the received request message.

According to a possible implementation, the request message can include at least one identifier of network assistance information associated with AI. The network assistance information can include one or more of an identifier of a type of a node of the network entity, one or more parameters of the network entity, and/or a name of the network entity.

According to a possible implementation, the request message can include an inquiry for a set of conditions associated with the at least one AI functionality. The response message can indicate one or more conditions associated with the at least one AI functionality based at least in part on the inquiry for the set of conditions associated with the at least one AI functionality.

It should be noted that the method described herein describes a possible implementation, and that the operations and the steps may be rearranged or otherwise modified and that other implementations are possible.

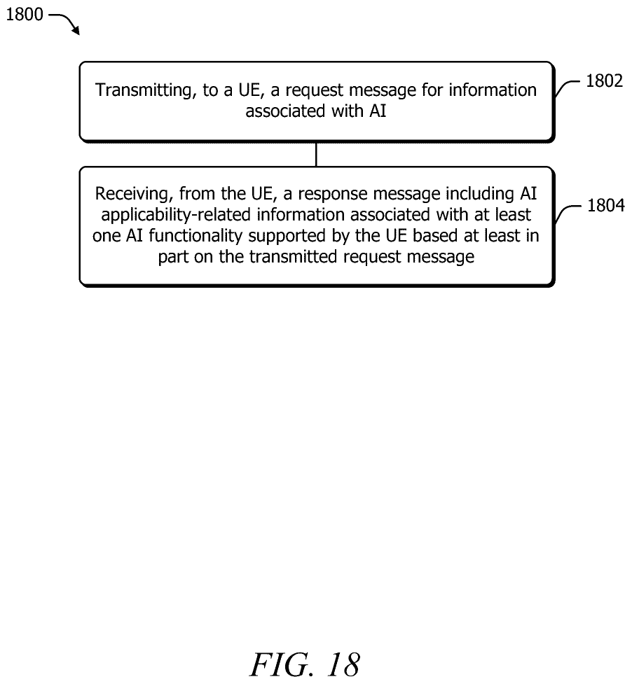

FIG. 18 illustrates a flowchart 1800 of a method in accordance with aspects of the present disclosure. The operations of the method may be implemented by a NE as described herein. In some implementations, the NE may execute a set of instructions to control the function elements of the NE to perform the described functions. Each operation of the flowchart 1800 may be performed in accordance with the examples described herein. In some implementations, aspects of particular operations may be performed by an NE 1600 as described with reference to FIG. 16.

At 1802, the method can include transmitting, to a UE, a request message for information associated with AI. At 1804, the method can include receiving, from the UE, a response message including applicability-related information associated with at least one AI functionality supported by the UE based at least in part on the transmitted request message.

It should be noted that the method described herein describes a possible implementation, and that the operations and the steps may be rearranged or otherwise modified and that other implementations are possible.

At least some embodiments can provide for UE-sided models a request/response of the applicability of a specific AI/ML functionality and its configurations. In a possible example, the NW sends a request to the UE, such as an AI/ML applicability request, to inquire about the applicability of the AI/ML functionality/model and the configurations. The applicability request can be a generic request or a functionality-specific request. The UE sends a response, such as an AI/ML applicability response, providing information about the all/subset of supported configurations for an applicable AI/ML functionality and additional conditions. The NW configures the UE for the AI/ML functionality after receiving an acknowledgment, otherwise it can reconfigure/deconfigure the UE for this AI/ML functionality.

In an example for applicability reporting, the UE proactively reports its applicability of AI/ML functionality to the NW, including additional details such as a list of all or a subset of applicable configurations for the functionality. The NW configures the UE for one of the applicable configurations or it can send another applicability request for a specific functionality. UE can send an update about the configurations and the applicability of AI/ML functionality in a status report message.

At least some embodiments can provide NW-sided models where signaling for additional conditions as a request/response message sequence can provide information such as UE-side additional conditions, which can support the NW to choose a suitable AI/ML model. Additional conditions are sent by the UE in the form of associated ID(s).

At least some embodiments can provide two-sided models where a combination of UE-sided and NW-sided signaling provides for the exchange of NW-sided conditions for the UE-side part and UE-sided conditions for the NW-side part or both.

A possible embodiment can provide a method in a UE. The method can include receiving a downlink message, where the message includes an AI/ML information element (IE). The method can include receiving a request message, where the message includes at least one selected from an identifier of the type of node (e.g., vendor information), inquiry about applicability for a functionality, and identifier(s) of NW-side additional conditions. The method can include transmitting a message (response/report), where the message includes at least one selected from all/subset of applicable configurations of an AI/ML functionality and identifier(s) of additional conditions. The method can include receiving a part/full configuration for the AI/ML functionality.

In a possible implementation, the downlink message contains UE capability inquiry. In a possible implementation, the applicability of AI/ML functionality/model depends on the identifier of the type of node received in the request message. In a possible implementation, the response message contains ACK/NACK for the AI/ML functionality and/or an identifier of additional conditions. In a possible implementation, the identifier of network-side additional conditions identifies at least one network entity state and the identifier for UE-side additional conditions identifies at least one UE-state. In a possible implementation, the configuration and identifier of additional conditions for functionality is used for AI/ML inference. In a possible implementation, the set of identifiers for a second network entity is sent to a first network entity.

A possible embodiment can provide a method in a network equipment. The method can include transmitting a request message (UE capability), where the message contains an AI/ML information element (IE). The method can include receiving a message from the UE, where the applicable configurations for the AI/ML functionalities are indicated in the received message. The method can include transmitting a request message to the UE inquiring about the applicability and/or configurations of supported AI/ML functionalities/models. The method can include transmitting a part/full configuration for AI/ML functionality, where the configuration can be used, such as required, to determine the applicability of an AI/ML functionality. The method can include configuring the UE if a desired configuration is present in the response message.

In a possible implementation, the AI/ML IE contains parameters relevant to AI/ML use cases. In a possible implementation, the NW reconfigures or deconfigures the UE if an applicable AI/ML model/configuration is not present or cannot be activated. In a possible implementation, the network equipment can be a first network entity and the first network entity sends the set of identifiers to a second network entity.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

At least some methods of this disclosure can be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

At least some embodiments can improve operation of the disclosed devices. Various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

An article “a” before an element is unrestricted and understood to refer to “at least one” of those elements or “one or more” of those elements. The terms “a,” “at least one,” “one or more,” and “at least one of one or more” may be interchangeable. For example, an element proceeded by “a,” “an,” or the like does not, without more constraints, preclude the existence of additional identical elements in the process, method, article, or apparatus that comprises the element. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). For example, the phrase “at least one of,” “at least one selected from the group of,” or “at least one selected from” followed by a list is defined to mean one, some, or all, but not necessarily all of, the elements in the list. Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “comprises,” “comprising,” “including,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Also, the term “another” is defined as at least a second or more. The terms “including,” “having,” and the like, as used herein, are defined as “comprising.” Terms of approximation, such as “approximately,” “near,” “substantially,” and/or other related terms, unless otherwise defined, are defined as a range within +/−5% of the approximated element, a range within +/−10% of the approximated element, and/or a range close enough to the approximated element to achieve an intended result. All elements of the disclosed embodiments can be modified with such terms. In this document, relational terms such as “first,” “second,” and the like may be used solely to distinguish one entity or action from another entity or action without necessarily requiring or implying any actual such relationship or order between such entities or actions.

The background section is not admitted as prior art, is written as the inventor's own understanding of the context of some embodiments at the time of filing, and includes the inventor's own recognition of any problems with existing technologies and/or problems experienced in the inventor's own work.

The following abbreviations are defined for this disclosure: 3GPP: 3rd Generation Partnership Project; 5G: Fifth Generation; 5G-CRG: 5G-Cable Residential Gateway; 5G-GUTI: 5G-Global Unique Temporary Identifier; 5G-S-TMSI: 5G Short-Temporary Mobile Subscription Identifier; 5G-TMSI: 5G Temporary Mobile Subscription Identifier; ACK: Acknowledgement; A-CSI: Aperiodic CSI; AF: Application Function; AI: Artificial Intelligence; AMF: Access and Mobility Management Function; BFD: Beam Failure Detection; BWP: Bandwidth Part; CA: Carrier Aggregation; CC: Component Carrier; CCCH SDU: Common Control Channel Service Data Unit; CCE: Control Channel Element; CDMA: Code Division Multiple Access; CM: Connection Management; CORESET: Control Resource Set; CRC: Cyclic Redundancy Check; CRI: CSI-RS Resource Index; C-RNTI: Cell RNTI; CSI-RS: Channel State Information Reference Signal; CSI: Channel State Information; CSS: Common Search Space; D2D: Device-to-Device; DCI: Downlink Control Information; DL: Downlink; DMRS: Demodulation Reference Signal; DRX: Discontinuous Reception; E-UTRAN: Evolved Universal Terrestrial Access Network; eNB: Enhanced NodeB; FDD: Frequency Division Duplex; FN-BRG: Fixed Network Broadband RG; FN-CRG: Fixed Network Cable RG; GCI: Global Cable identifier; GERAN: GSM EDGE Radio Access Network; GLI: Global Line Identifier; gNB: New Radio NodeB; GPSI: Generic Public Subscription Identifier; GUAMI: Global Unique AMF Identifier; GUE: Gateway UE; GUTI: Global Unique Temporary Identifier; HARQ-ACK: Hybrid Automatic Repeat Request-Acknowledgement; HST: High Speed Train; ID: Identifier; IE: Information Element; IIoT: Industrial Internet of Things; IMEI: International Mobile Equipment Identity; IMEISV: International Mobile Equipment Identity Software Version; IMSI: International Mobile Subscriber Identity; IoT: Internet of Things; I-RNTI: Inactive Radio Network Temporary Identifier; LTE: Long Term Evolution; MAC: Medium Access Control; MAC CE: Medium Access Control Control Element; MCG: Master Cell Group; MCS: Modulation and Coding Scheme; ML: Machine Learning; MPE: Maximum Permissible Exposure; MPO: MsgA PUSCH Occasion; MsgA: Message A; MsgB: Message B; MTC: Machine Type Communication; NACK: Non-Acknowledgement; NE: Network Element; NEF: Network Exposure Function; NG-RAN: Next-Generation Radio Access Network; NR: New Radio; NUL: Non-supplementary Uplink; OAM: Operations, Administration and Maintenance; OFDMA: Orthogonal Frequency Division Multiple Access; PCell: Primary Cell; PDCCH: Physical Downlink Control Channel; PDSCH: Physical Downlink Shared Channel; PDU: Protocol Data Unit; PEI: Permanent Equipment Identifier; PF: Paging Frame; PHR: Power Headroom Report; MPE-P-MPR: Maximum Permitted Exposure Power Management Maximum Power Reduction; P-MPR: Power Management Maximum Power Reduction; PO: Paging Occasion; PRACH: Physical Random Access Channel; PSCell: Primary Secondary Cell; PS-RNTI: Power Saving RNTI; PUCCH: Physical Uplink Control Channel; PUSCH: Physical Uplink Shared Channel; QCL: Quasi-co-location; RACH: Random Access Channel (Procedure); RAN: Radio Access Network; RAR: Random Access Response; RG: Residential Gateway; RLF: Radio Link Failure; RLM: Radio Link Monitoring; RM: Registration Management; RNA: RAN-based Notification Area; RNTI: Radio Network Temporary Identifier; RRC: Radio Resource Control; RRM: Radio Resource Management; RS: Reference Signal; RSRP: Reference Signal Received Power; RUE: Real UE (non-virtual UE); SAR: Specific Absorption Rate; SCell: Secondary Cell; SCG: Secondary Cell Group; SCS: Subcarrier Spacing; SFI: Slot Format Indicator; SFN: Single Frequency Network; S-NSSAI: Single Network Slice Selection Assistance Information; SpCell: Special Cell (i.e. a PCell of a MCG or SCG); SP-CSI: Semi-persistent CSI; SR: Scheduling Request; SRI: SRS Resource Indicator; SRS: Sounding Reference Signal; SPS: Semi-persistent scheduling; SS: Search space; SS/PBCH: Synchronization Signal/Physical Broadcast Channel; SSBRI: SS/PBCH Block Resource Index; SUL: Supplementary Uplink; SUPI: Subscription Permanent Identifier; TB: Transport block; TCI: Transmission Configuration Indicator; TC-RNTI: Temporary Cell RNTI; TDD: Time Division Duplex; TDMA: Time Division Multiple Access; TMSI: Temporary Mobile Subscriber Identity; TPC: Transmit Power Control; TRP: Transmission and Reception Point; UCI: Uplink Control Information; UDM: Unified Data Management; UDR: Unified Data Repository; UE: User Equipment; UL: Uplink; UPF: User Plane Function; URLLC: Ultra-Reliable Low-Latency Communication; USS: UE-specific Search Space; VUE: Virtual UE; W-5GAN: Wireline 5G Access Network; XR: extended Reality

What is claimed is:

1. A user equipment (UE) for wireless communication, comprising:
at least one memory; and
at least one processor coupled with the at least one memory and configured to cause the UE to:
receive, from a network entity, a request message for information associated with artificial intelligence (AI); and
transmit, to the network entity, a response message including applicability-related information associated with at least one AI functionality supported by the UE based at least in part on the received request message.

2. The UE of claim 1, wherein the request message comprises at least one identifier of network assistance information associated with AI, where the network assistance information comprises one or more of an identifier of a type of a node of the network entity, one or more parameters of the network entity, or a name of the network entity.

3. The UE of claim 1, wherein
the request message comprises an inquiry for a set of conditions associated with the at least one AI functionality, and
the response message indicates one or more conditions associated with the at least one AI functionality based at least in part on the inquiry for the set of conditions associated with the at least one AI functionality.

4. The UE of claim 3, wherein the one or more conditions comprise one or more of a memory condition of the UE, a battery condition of the UE, or hardware limitations of the UE for an AI-enabled feature.

5. The UE of claim 1, wherein the response message includes one or more of: a subset of AI functionalities of a set of AI functionalities supported by the UE, a set of one or more configurations associated with the at least one AI functionality, or at least one identifier of at least one condition associated with at least one AI functionality.

6. The UE of claim 1, wherein the information associated with AI indicates an applicability of the at least one AI functionality supported by the UE, where the applicability of the at least one AI functionality supported by the UE is based at least in part on an identifier of a type of node or a condition, wherein the identifier is received in the request message.

7. The UE of claim 1, wherein the at least one processor is configured to cause the UE to receive at least a subset of a first configuration associated with the at least AI functionality, or an indication to activate a second configuration associated with the at least AI functionality.

8. The UE of claim 1, wherein the request message comprises a UE capability request message, and wherein the response message comprises a UE capability response message.

9. A processor for wireless communication, comprising:
at least one controller coupled with at least one memory and configured to cause the processor to:
receive, from a network entity, a request message for information associated with artificial intelligence (AI); and
transmit, to the network entity, a response message including applicability-related information associated with at least one AI functionality supported by a UE based at least in part on the received request message.

10. The processor of claim 9, wherein the request message comprises at least one identifier of network assistance information associated with AI, where the network assistance information comprises one or more of an identifier of a type of a node of the network entity, one or more parameters of the node of the network entity, or a name of the node of the network entity.

11. The processor of claim 9, wherein
the request message comprises an inquiry for a set of conditions associated with the at least one AI functionality, and
the response message indicates one or more conditions associated with the at least one AI functionality based at least in part on the inquiry for the set of conditions associated with the at least one AI functionality.

12. The processor of claim 9, wherein the information associated with AI indicates an applicability of the at least one AI functionality supported by the UE, where the applicability of the at least one AI functionality supported by the UE is based at least in part on an identifier of a type of node or a condition, wherein the identifier is received in the request message.

13. A base station for wireless communication, comprising:
at least one memory; and
at least one processor coupled with the at least one memory and configured to cause the base station to:
transmit, to a user equipment (UE), a request message for information associated with artificial intelligence (AI); and
receive, from the UE, a response message including applicability-related information associated with at least one AI functionality supported by the UE based at least in part on the received request message.

14. The base station of claim 13, wherein the request message comprises at least one identifier of network assistance information associated with AI, where the network assistance information comprises one or more of an identifier of a type of a node of the base station, one or more parameters of the base station, or a name of the base station.

15. The base station of claim 13, wherein
the request message comprises an inquiry for a set of conditions associated with the at least one AI functionality, and
the response message indicates one or more conditions associated with the at least one AI functionality based at least in part on the inquiry for the set of conditions associated with the at least one AI functionality.

16. The base station of claim 13, wherein the information associated with AI indicates an applicability of the at least one AI functionality supported by the UE, where the applicability of the at least one AI functionality supported by the UE is based at least in part on an identifier of a type of node or a condition, wherein the identifier is received in the request message.

17. The base station of claim 13, wherein the at least one processor is configured to cause the base station to send applicability-related information for at least one AI functionality to at least one network entity other than the base station.

18. A method performed by a user equipment (UE), the method comprising:
receiving, from a network entity, a request message for information associated with artificial intelligence (AI); and
transmitting, to the network entity, a response message including applicability-related information associated with at least one AI functionality supported by the UE based at least in part on the received request message.

19. The method of claim 18, wherein the request message comprises at least one identifier of network assistance information associated with AI, where the network assistance information comprises one or more of an identifier of a type of a node of the network entity, one or more parameters of the network entity, or a name of the network entity.

20. The method of claim 18, wherein
the request message comprises an inquiry for a set of conditions associated with the at least one AI functionality, and
the response message indicates one or more conditions associated with the at least one AI functionality based at least in part on the inquiry for the set of conditions associated with the at least one AI functionality.
